(19) United States
(12) Patent Application Publication
(10) Pub. No.: US 2023/0051412 A1
(43) Pub. Date: Feb. 16, 2023

(54) Motion vector prediction for video coding

(71) Applicants: Koninklijke KPN N.V., Rotterdam (NL); Nedertandse Organisatie Voor Toegepast-Natuurwetenschappelijk Onderzoek TNO, ‘s-Gravenhage (NL)

(72) Inventors: Alexandre da Silva Pratas Gabriel, The Hague (NL); Emmanuel Thomas, Delft (NL); Omar Aziz Niamut, Vlaardingen (NL)

(21) Appl. No.: 17/789,457

(22) PCT Filed: Dec. 24, 2020
(86) PCT No.: PCT/EP2020/087852

§ 371 Date: Jun. 27, 2022

(30) Foreign Application Priority Data
Dec. 27, 2019 (EP) 19219743.2

(51) Int. Cl. H04N 19/137; H04N 19/105; H04N 19/176

(52) U.S. Cl. CPC H04N 19/137; H04N 19/105; H04N 19/176

(57) ABSTRACT

Methods and systems for providing a bitstream comprising video data encoded by an encoder apparatus are described, wherein the method may include: a processor of the encoder apparatus determining a current motion vector of a current block of a current video frame of a sequence of video frames comprising video data, the current motion vector defining a spatial offset of the current block relative to a prediction block of a previously encoded reference video frame stored in a memory of the encoder apparatus; the processor determining or receiving motion information associated with the current video frame, the motion information signaling the processor whether at least part of the offset defined by the current motion vector is associated with non-uniform motion in the video data of the current video frame; the processor determining a motion vector predictor candidate based on the motion information, at least a first motion vector predicator algorithm and a second motion vector predictor algorithm; and, the processor determining a motion vector difference based on the selected motion vector predictor candidate and the current motion vector; and, the processor using an encoding process to encode a residual block, the motion vector difference, an indication of the selected motion vector predictor candidate, and at least part of the motion information into a bitstream, wherein the residual block defines a difference between the current block and the prediction block.

### FIELD OF THE INVENTION

The invention relates to motion vector prediction for video coding, and, in particular, though not exclusively, to methods and systems for motion vector prediction, a video decoder apparatus and a video encoder apparatus using such methods and a computer program product for executing such methods.

### BACKGROUND OF THE INVENTION

State of the art video coding standards use a hybrid block-based video coding scheme wherein a video frame is partitioned into video blocks which are subsequently encoded using prediction block-based compression techniques. Here, a video block or in short a block refers to a basic processing unit of a video standard, e.g., coding tree units (CTUs) as defined in HEVC, macroblocks as defined in AVC and super blocks as defined in VP9 and AV1. In certain video coding standards, such as HEVC, blocks may be partitioned into smaller sub-blocks e.g. Coding Units (CUs) and Prediction Units (PUs). Different prediction modes may be used to code each of the blocks or sub-blocks. For example, different intra-prediction modes may be used to code a block based on predictive data within the same frame so as to exploit spatial redundancy within a video frame. Additionally, inter-prediction modes may be used to code a block based on predictive data from another frame so that temporal redundancy across a sequence of video frames can be exploited.

Inter-prediction uses a motion estimation technique to determine motion vectors (MVs), wherein a motion vector identifies a block in an already encoded reference video frame (past or future video frame) that is suitable for predicting a block in a video frame that needs to be encoded wherein the block that needs to be encoded and its associated MV are typically referred to as the current block and the current MV respectively. The difference between a prediction block and a current block may define a residual block, which can be encoded together with metadata, such as the MV and transmitted to a video playout device that includes a video decoder for decoding the encoded information using the metadata. In turn, MVs may be compressed by exploiting correlations between motion vectors of blocks that have been already encoded and a motion vector of a current block. Translational moving objects in video pictures typically cover many blocks that have similar motion vectors in direction and length. Video coding standards typically exploit this correlation.

For example, motion vector compression schemes such as the so-called Advanced Motion Vector Prediction (AMVP) algorithm used by HEVC or the Dynamic Reference Motion Vector Prediction (REFMV) used by AV1, aim to compress information about motion vectors in the bitstream by using a motion vector that already has been calculated as a reference for predicting a current MV. Such motion vector may be referred to as a motion vector predictor (MVP). In this scheme, a MVP for a MV of a current block may be generated by determining candidate MVs of already encoded blocks of the current video frame or co-located blocks of an encoded reference video frame and selecting a candidate MV as the best predictor, a MVP, for the current block based on an optimization scheme such as a well-known rate distortion and optimization (RDO) scheme. The difference between the MVP and the MV and information about the selected motion vector predictor is entropy coded into a bitstream. The decoder uses the information of the selected MVP and the MV difference to reconstruct a motion vector of a current block that needs to be decoded. The motion vector compression schemes of the video standards are all based on the fact that encoded blocks close to the current block, e.g. neighbouring blocks in the same video frame, or encoded co-located blocks in a reference frame, will typically have the same or similar motion vector values due to the spatial correlation of pixels in blocks of consecutive frames.

A problem associated with the inter-prediction algorithms used by most coding standards is that these algorithms assume that motion in pictures relates to uniform translational movement of objects in the video. A motion estimation technique will associated such moving object with a uniform motion vector field (i.e. all motion vectors have approximately the same size and direction). Motion vectors determined by a motion estimation technique however provide an estimate of all motion in video blocks of a video frame, translational local motion associated with moving objects as well as other types of motion in a video. For example, a moving camera may introduce a non-uniform motion vector field, especially if the camera is a 360 camera that generate projected video frames (e.g. video frames comprising equirectangular projected pixels). In most video coding standards, such as AVC and HEVC, inter-prediction schemes and associated motion vector predictor schemes are mainly optimized for dealing with uniform motion vector fields. This may result in suboptimal coding and compression efficiency.

Hence, from the above it follows there is a need in the art for improved methods and systems for coding of video data that includes a global motion field that is caused by motion, in particular camera motion.

### SUMMARY OF THE INVENTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by a microprocessor of a computer. Furthermore, aspects of the present invention may take the form of a computer program product embodied in one or more computer readable medium(s) having computer readable program code embodied, e.g., stored, thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor, in particular a microprocessor or central processing unit (CPU), of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. Additionally, the Instructions may be executed by any type of processors, including but not limited to one or more digital signal processors (DSPs), general purpose microprocessors, application specific integrated circuits (ASICs), field programmable logic arrays (FP-GAs), or other equivalent integrated or discrete logic circuitry.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

The embodiments in this application aim to improve the efficiency of coding video, that includes non-uniform motion, e.g. non-uniform global motion or non-uniform local motion relating to rotating objects. Non-uniform global motion due to movement of the camera that captures the video which can either be a virtual (computer generated world) or a real camera. Here, the movement may be associated with a physically moving camera (e.g. due to a panning or tilting operation), or with a virtually moving camera (e.g. due to a zooming action).

In known motion vector predictor schemes such as AMVP and REFMV an algorithm is used by the encoder and the decoder for building a list of motion vector predictor candidates by first reviewing predetermined motion vectors of encoded blocks of the current video frame (the so-called spatial motion vector predictor candidates) and—if these are not available—then reviewing predetermined motion vectors of blocks of one or more reference frames (the so-called temporal motion vector predictor candidates). Applying such algorithm to video frames comprising non-uniform motion will result in inaccurate motion vector predictors since the motion vectors of encoded blocks of the current video will likely be of different intensities and direction and thus suboptimal compression.

The inventors recognized that a non-uniform motion field in video frames results in low correlation between motion vectors of blocks that are positioned within the vicinity of the current block, a strong correlation however exists between motion vectors of blocks in one or more reference frames. This insight may be used to improve motion vector predictor schemes for predicting motion vectors of blocks that include non-uniform motion. Further, the inventors recognized that non-uniform motion fields in video frames may have distinct and predictable patterns, which depend on the type of video data in the video frames. For example, in case of spherical video non-uniform global motion due to camera movement has a distinct and predictable pattern, depending on the projection that is used to project the spherical video onto a rectangular 2D plane of a video frame. For example, in an equirectangular (ERP) projected video frame, camera motion may cause a characteristic pattern in the video including an expansion point and a compression point in the video frames. Pixels in the area around expansion points may have motion vectors that point in opposite directions with their tails located at the same point (expansion point) and pixels in the area around compression points may have motion vectors that point toward the same point (compression point) causing complex but accurately predictable motion patterns in these two types of area. Such patterns can be predicted using a simple parametric algorithm that models the movement of the camera in the 3D scene, hence causing a global motion in the captured video. This insight may also be used to improve motion vector predictor schemes for predicting motion vectors of blocks that include non-uniform motion.

In an aspect, the invention may relate to a method of providing a bitstream comprising video data encoded by an encoder apparatus. In an embodiment, the method may comprise a processor of the encoder apparatus determining a current motion vector of a current block of a current video frame of a sequence of video frames comprising video data.

The method may also comprise the processor determining or receiving motion information, the motion information defining whether the current block is part of a set of blocks in the current video frame that is associated with a non-uniform motion vector field.

The method may also comprise the processor determining a motion vector predictor candidate, wherein the determining includes: selecting one of a plurality of motion vector predictor algorithms, the plurality of motion vector predictor algorithms including at least a first motion vector predictor algorithm and a second motion vector predictor algorithm, the selection being based on the motion information; determining a list of motion vector predictor candidates based on the selected motion vector predictor algorithm; and, selecting the motion vector predictor candidate from the list of motion vector predictor candidates.

The method may further comprise determining a motion vector difference based on the selected motion vector predictor candidate and the current motion vector.

The method may also comprise the processor generating a bitstream, the generating including encoding the motion vector difference, the indication of the selected motion vector predictor candidate and a residual block, the residual block defining a difference between the current block and the prediction block.

In an embodiment, the generating a bitstream may comprise inserting an indication of the selected motion vector predictor algorithm or at least part of the motion information into the bitstream. In an embodiment, the method may further comprise the processor instructing a transmitter to transmit the bitstream to a receiver. Hence, in this embodiment, the indication of a motion vector predictor algorithm as selected by the encoder on the basis of the motion information or the motion information is transmitted in the bitstream, e.g. in-band, to a receiver.

In another embodiment, the method may comprise the processor instructing a transmitter to transmit the bitstream and the indication of a motion vector predictor algorithm selected by the encoder or the motion information to a receiver. In this embodiment, the indication of a motion vector predictor algorithm or the motion information may be transmitted separately from the bitstream, e.g. out-of-band, to a receiver.

The current motion vector may define a spatial offset of the current block relative to a prediction block of a previously encoded reference video frame stored in a memory of the encoder apparatus.

In an embodiment, the selection of the motion vector predictor candidate may be based on an optimization scheme such as a rate distortion optimization process.

The invention uses motion information associated with the current video frame to determine motion vector predictor candidates. If non-uniform motion is present in the current video frame (or a region in the current video frame) then the associated motion vectors may form a non-uniform motion vector field. If such non-uniform motion vector field is determined or signaled, a motion vector predictor algorithm can be selected which takes the non-uniform motion vector field into account when generating motion vector predictor candidates. This way, the compression efficiency can be improved.

In this application, the term prediction block refers to a set of reference samples in one or more reference frames that are used to predict the current block. The reference samples of a prediction block do not necessarily have a one to one correspondence with samples of the current block. Often the reference samples are used in an interpolation scheme to predict samples of the current block. Further, it is submitted that the samples of a prediction block may have any suitable shape, e.g. a polygon including rectangular, triangular or other shapes.

In an embodiment, selecting one of a plurality of motion vector predictor algorithms may include: selecting the first motion vector predictor algorithm, if the motion information defines that the current block is part of a set of blocks that are associated with a non-uniform motion vector field; and, selecting the second motion vector predictor algorithm, if the motion information defines that the current block is part of a set of blocks that are associated with a uniform motion vector field.

In an embodiment, determining a list of motion vector predictor candidates may include: the first motion vector predictor algorithm determining at least part of the list of motion vector predictor candidates based on one or more motion vectors of one or more already encoded blocks of one or more reference video frames stored in the memory of the encoder apparatus; or, the first motion vector predictor algorithm determining at least part of the list of motion vector predictor candidates based on a parametric model of the non-uniform motion vector field. In an embodiment, the parametric model may be a parametric algorithm configured to compute the non-uniform motion vector field at the position of the current block.

Hence, in these embodiments, a first algorithm may be used to first evaluate temporal candidates which—due to the non-uniform motion—may have a strong correlation with the motion vector of the current block. Alternatively, a parametric algorithm may be used to build at least part of the list of motion vector predictor candidates.

In an embodiment, the determining a list of motion vector predictor candidates may include: the second motion vector predictor algorithm determining at least part of the list of motion vector predictor candidates based on first evaluating one or more motion vectors of one or more already encoded blocks of the current video frame; and, optionally, after evaluating one or more motion vectors of one or more already encoded blocks of the current video frame, evaluating one or more motion vectors of one or more already encoded blocks of one or more reference video frames stored in the memory of the encoder apparatus.

In this embodiment, if the motion vector field is uniform, a second vector predictor algorithm may be used to determine candidates. In that case, a list may be built by first evaluating spatial candidates.

Current state of the art coding standards such as HEVC, VP9, AV1 and VVC use motion vector prediction schemes wherein first spatial candidates are evaluated and thereafter—if no or not enough suitable spatial candidates are found—temporal candidates. In case of non-uniform motion fields however such scheme does not yield proper motion vector predictors.

The embodiments in this application propose to determine a list of motion vector predictors candidates based on a first algorithm which is configured to first evaluate motion vector predictor candidates based on motion vectors associated with blocks of samples in references frames (i.e. temporal candidates) or to evaluate motion vector predictor candidates which are computed based on a parametric model of the non-motion field.

The schemes to determine a motion vector predictor candidate are both implemented in the encoder and decoder. The indication of the selected motion vector predictor candidate and the motion information are transmitted to the decoder which selects a motion vector prediction algorithm based on the motion information. The decoder may build a list candidates on the basis of the selected algorithm and use an indication of the motion vector predictor candidate selected by the encoder to select the motion vector prediction candidate that may be used for reconstructing a current block.

Thus, if a non-uniform motion vector field is present (if the non-uniformity of the motion vectors is above a certain threshold), a first motion vector predictor algorithm (a first algorithm) may be selected, which is configured to handle non-uniform motion vectors. This way, the compression efficiency can be improved. If no non-uniform motion vector field is present (if the non-uniformity of the motion vectors is below a certain threshold), the encoder may select a second motion vector predictor scheme (a second algorithm) that is optimized for uniform motion vectors (typically set of motion vectors representing translational motion) may be selected.

The second motion vector predictor algorithm may be used to build a list of motion vector predictor candidates by first evaluating spatial candidates. If no sufficient spatial candidates are available, the second motion vector predictor algorithm may evaluate temporal candidates, typically motion vectors of blocks of samples close to a block in the reference frame that is co-located with the current block of the current frame.

Based on the motion information, a first or second motion vector predictor algorithm may be used to build a candidate list by evaluation of motion vectors associated with blocks of samples that are already encoded. Deriving a list of candidates by evaluating temporal candidates first or by only evaluating temporal candidates will provide substantial advantages in the coding efficiency of video that comprises non-uniform motion vectors.

In an embodiment, the motion information may include one or more parameters for a map function, wherein the map function may be configured to determine or signal one or more first regions in the current frame for which the first algorithm may be used. In another embodiment, the map function may be configured or signal one or more second regions in the current frame for which the second algorithm may be used. The map function may be implemented in the encoder and the decoder so only one or more parameters are needed to determine the complete map.

In an embodiment, the indication of a motion vector predictor algorithm may include a value for signaling the processor to use the first motion vector predictor algorithm or the second motion vector predictor algorithm.

In an embodiment, the indication of a motion vector predictor algorithm may include a map, preferably a binary map, the map including a plurality of data units, e.g. bits or bytes, each data unit being associated with a block of the current frame, each data unit including a value for signaling the processor to use the first motion vector predictor algorithm or the second motion vector predictor algorithm.

In an embodiment, the indication of a motion vector predictor algorithm may include a map defining one or more first regions for which the first algorithm is used and. In an embodiment, the map may include one or more second regions in the current frame for which the second algorithm is used.

In an embodiment, the video frames of the sequence of video frames may comprise spherical video data. In an embodiment, the spherical video data may be projected onto a rectangular video frame based on a projection model. In an embodiment, the projection model may be an equirectangular or a cubic projection model.

In an embodiment, at least part of the motion information may be included in the bitstream as one or more network abstraction layer, NAL, units. Such NAL units may include at least one of: a non-VCL NAL unit such as a Picture Parameter Set, PPS, or a Sequence Parameter Set, SPS. These NAL units may be NAL units as defined in the HEVC coding standard or coding standard based on the HEVC standard.

In an embodiment, at least part of the motion information may be included in the bitstream in a Slice Header as defined in the VVC coding standard or a Slice Header as defined in the AVC or HEVC coding standard. The encoding and decoding processes in this application may be based on a coding standard, such as a block-based video coding standard. In an embodiment, the video coding standard may be based on one of the AVC, HEVC, VP9, AV1, or VVC coding standard or a coding standard based on one of these standards.

In an embodiment, the processor determining motion information may include: comparing a magnitude and/or a direction of motion vectors of blocks in a region of the current video frame; and, determining that the motion vectors in the region belong to a non-uniform motion field based on the compared magnitudes and/or directions.

Hence, motion vectors associated with blocks in a video frame may define a motion vector field. A set of rules can be used to evaluate the size and direction of motion vectors of the motion vector field of a block-partitioned picture to decide if a set of motion vectors define a uniform or a non-uniform motion vector field. For example, a motion vector field may be determined as uniform if the magnitude and/or direction of motion vectors of a set of blocks in a region of a video frame are substantially the same (wherein deviations within a limited range may be allowable). In other words, the motion vector field may be determined as uniform if the differences in the magnitude and/or direction of motion vectors associated with the set of blocks are below a certain a value, e.g. a threshold value. A motion vector field may be determined as non-uniform if the size and direction of motion vectors of a set of blocks in a frame exhibits substantial differences. For example, differences in the magnitude and/or direction of motion vectors associated with a set of blocks in a particular area in a video frame may be larger than a certain value, e.g. a threshold value.

A non-uniform motion vector field may be caused by camera movements. In that case the motion vector field may be referred to as a global motion vector field. Non-uniform global motion can be modelled, e.g. described based on a mathematical function. Examples of such functions are described in this application. In case of non-uniform local motion vector field, e.g. a vector field associated with a non-uniform moving (e.g. rotating) object, such non-uniform vector fields may be determined by performing object analysis and motion vector analysis on a sequence of video frames.

In an aspect, the invention may relate to a method for reconstructing a block of a video frame from a bitstream encoded by an encoder apparatus, wherein the method may comprise the steps of: a processor of a decoder apparatus receiving a bitstream comprising an encoded current block of a current video frame to be decoded by the decoder apparatus based one or more already decoded prediction blocks of one or more reference video frames stored in the memory of the decoder apparatus and based on a current motion vector representing a spatial offset of the current block relative to one of the one or more prediction blocks, the current motion vector being associated with a motion vector predictor candidate; the processor receiving an indication of a motion vector predictor algorithm selected by an encoder for determining a list of motion vector predictor candidates from which the encoder has selected the motion vector predictor candidate; or, the processor receiving motion information defining whether the current block is part of a set of blocks in the current frame that is associated with a non-uniform motion vector field, preferably a non-uniform global motion vector field; the processor decoding the encoded current block into a residual block, a motion vector difference and an indication of the selected motion vector predictor candidate, the residual block defining a difference between one of the one or more already decoded prediction blocks and the current block; the processor determining the motion vector predictor candidate, the determining including: selecting one of a plurality of motion vector predictor algorithms, the plurality of motion vector predictor algorithms including at least a first motion vector predictor algorithm and a second motion vector predictor algorithm, the selection being based on the indication of a motion vector predictor algorithm or the motion information; determining the list of motion vector predictor candidates based on the selected motion vector predictor algorithm; selecting the motion vector predictor candidate from the list of motion vector predictor candidates.

In an embodiment, the method may further comprise the processor determining the current motion vector based on the selected motion vector predictor candidate and the motion vector difference; and, the processor reconstructing the current block based on the prediction block and the residual block, the reconstructing including using the current motion vector to identify the prediction block of a reference video frame stored in the memory of the decoder apparatus.

In an embodiment, the selecting one of a plurality of motion vector predictor algorithms based on the motion information may include: selecting the first motion vector predictor algorithm, if the motion information defines that the current block is part of a set of blocks that are associated with a non-uniform motion vector field; and, selecting the second motion vector predictor algorithm, if the motion information defines that the current motion vector is part of a set of blocks that are associated with a uniform motion vector field.

In an embodiment, the determining a list of motion vector predictor candidates may include: the first motion vector predictor algorithm determining at least part of the list of motion vector predictor candidates based on one or more motion vectors of one or more already encoded blocks of one or more reference video frames stored in the memory of the encoder apparatus; or, the first motion vector predictor algorithm determining at least part of the list of motion vector predictor candidates based on a parametric model of the non-uniform motion vector field, preferably the parametric model representing a parametric algorithm configured to compute the non-uniform motion vector field at the position of the current block.

In a further aspect, the invention may relate to an encoding apparatus comprising: a computer readable storage medium having at least part of a program embodied therewith; and, a computer readable storage medium having computer readable program code embodied therewith, and a processor, preferably a microprocessor, coupled to the computer readable storage medium, wherein responsive to executing the computer readable program code, the processor is configured to perform executable operations comprising: determining a current motion vector of a current block of a current video frame of a sequence of video frames comprising video data, the current motion vector defining a spatial offset of the current block relative to a prediction block of a previously encoded reference video frame stored in a memory of the encoder apparatus; determining or receiving motion information, the motion information defining the processor whether the current block is part of a set of blocks in the current video frame that is associated with a non-uniform motion vector field, preferably a non-uniform global motion vector field, in the video data of the current video frame; determining a motion vector predictor candidate, wherein the determining includes: selecting one of a plurality of motion vector predictor algorithms, the plurality of motion vector predictor algorithms including at least a first motion vector predictor algorithm and a second motion vector predictor algorithm, the selection being based on the indication of a motion vector predictor algorithm or the motion information; determining a list of motion vector predictor candidates based on the selected motion vector predictor algorithm; selecting the motion vector predictor candidate from the list of motion vector predictor candidates, preferably the selecting being based on an optimization scheme such as a rate distortion optimization process; determining a motion vector difference based on the selected motion vector predictor candidate and the current motion vector; and, generating a bitstream, the generating including encoding the motion vector difference, an indication of the selected motion vector predictor candidate and a residual block, the residual block defining a difference between the current block and the prediction block and, optionally, inserting an indication of the selected motion vector predictor algorithm or at least part of the motion information into the bitstream.

The encoding apparatus may be configured to execute any of the steps performed by an encoder apparatus as described by the embodiments in the application.

In yet a further aspect, the invention may relate to a decoding apparatus comprising: a computer readable storage medium having at least part of a program embodied therewith; and, a computer readable storage medium having computer readable program code embodied therewith, and a processor, preferably a microprocessor, coupled to the computer readable storage medium, wherein responsive to executing the computer readable program code, the processor is configured to perform executable operations comprising: receiving a bitstream comprising an encoded current block of a current video frame to be decoded by the decoder apparatus based one or more already decoded prediction blocks of one or more reference video frames stored in the memory of the decoder apparatus and based on a current motion vector representing a spatial offset of the current block relative to one of the one or more prediction blocks, the current motion vector being associated with a motion vector predictor candidate; receiving an indication of a motion vector predictor algorithm selected by an encoder for determining a list of motion vector predictor candidates from which the encoder has selected the motion vector predictor candidate; or, receiving motion information defining whether the current block is part of a set of blocks in the current frame that is associated with a non-uniform motion vector field, preferably a global motion vector field; decoding the encoded current block into a residual block, a motion vector difference and the indication of a motion vector predictor candidate selected by the encoder apparatus, the residual block defining a difference between one of the one or more already decoded prediction blocks and the current block; determining a motion vector predictor candidate, the determining including: selecting one of a plurality of motion vector predictor algorithms, the plurality of motion vector predictor algorithms including at least a first motion vector predictor algorithm and a second motion vector predictor algorithm, the selection being based on the indication of a motion vector predictor algorithm or the motion information; determining the list of motion vector predictor candidates based on the selected motion vector predictor algorithm; selecting the motion vector predictor candidate from the list of motion vector predictor candidates; using the indication of the motion vector prediction candidate selected by the encoder to select the motion vector predictor candidate from the list of motion vector predictor candidates.

In a further embodiment, the executable operations may include: determining the current motion vector based on the selected motion vector predictor candidate and the motion vector difference; and, reconstructing the current block based on the prediction block and the residual block, the reconstructing including using the current motion vector to identify the prediction block of a reference video frame stored in the memory of the decoder apparatus.

The decoding apparatus may be configured to execute any of the steps performed by an decoder apparatus as described by the embodiments in the application.

In another embodiment, the first motion vector predictor algorithm may be configured to build a list of motion vector predictor candidates which is only based on motion vectors of already encoded blocks of one or more reference video frames stored in the memory of the encoder apparatus. In this embodiment, the spatial candidates are not evaluated at all.

In a further embodiment, the invention may relate to a decoding apparatus configured to execute any of the decoding processes defined in this application.

The invention may also relate to a computer program product comprising software code portions configured for, when run in the memory of a computer, executing the method steps according to any of process steps described above. In this application the following abbreviations and terms are used:

| | |
|---|---|
| AMVP | Advanced Motion Vector Prediction |
| ERP | Equirectangular Projection |
| RDO | Rate Distortion Optimization |
| 360 video | a video that represents a scene from a single position in a 3D space |
| | containing visual content for the complete or partial spherical view of the |
| | scene. |
| MV | a two-dimensional vector used for inter-prediction that defines an offset |
| | (Dx, Dy) of a current block relative to a prediction block of an already encoded |
| | reference video frame (past or future) stored in a memory of an encoder or |
| | decoder. The motion vector represents an estimate of the motion (in terms of |
| | magnitude and direction) of pixels of the current block. |
| MV field | the 2D space limited by the frame size in which motion vectors are located. |
| | The position of a motion vector is given by the position of the coding block to |
| | which it is associated. |
| MVP | a motion vector predictor is a MV belonging to another, already encoded or |
| | decoded block (of the current frame or a reference frame) which can be used |
| | as a predictor for the current MV in order to reduce the cost of coding the MVs |
| | (in terms of its x and y components). |

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1 depicts a flow-diagram of processing spherical video data.

FIG. 2 depicts an example of an equirectangular projection of spherical video data.

FIG. 3A-C depict different projections and mappings of spherical video data.

FIG. 4A-4F illustrates the concept of motion fields in projected spherical video data.

FIGS. 5A and 5B depict examples of time-averaged motion vector fields of 360 video frames.

FIGS. 6A and 6B depict examples of time-averaged motion vector fields of 2D video frames.

FIG. 7 depicts a motion vector prediction process according to an embodiment of the invention.

FIGS. 8A and 8B illustrate construction of a list of motion vector predictor candidates using a first algorithm.

FIG. 9 illustrates illustrate construction of a list of motion vector predictor candidates using another algorithm.

FIG. 10A-10C illustrate an example of motion information according to an embodiment of the invention.

FIG. 11 illustrates an encoder apparatus comprising a motion vector prediction unit according to an embodiment of the invention.

FIG. 12 illustrates a decoder apparatus comprising a motion vector prediction unit according to an embodiment of the invention.

FIGS. 13A and 13B depict a process flow of encoding and decoding video data according to an embodiment of the invention.

FIG. 14 illustrates an example of a motion information according to another embodiment of the invention.

FIG. 15 depicts a block diagram illustrating an exemplary data processing system that may be used with embodiments described in this disclosure.

### DETAILED DESCRIPTION

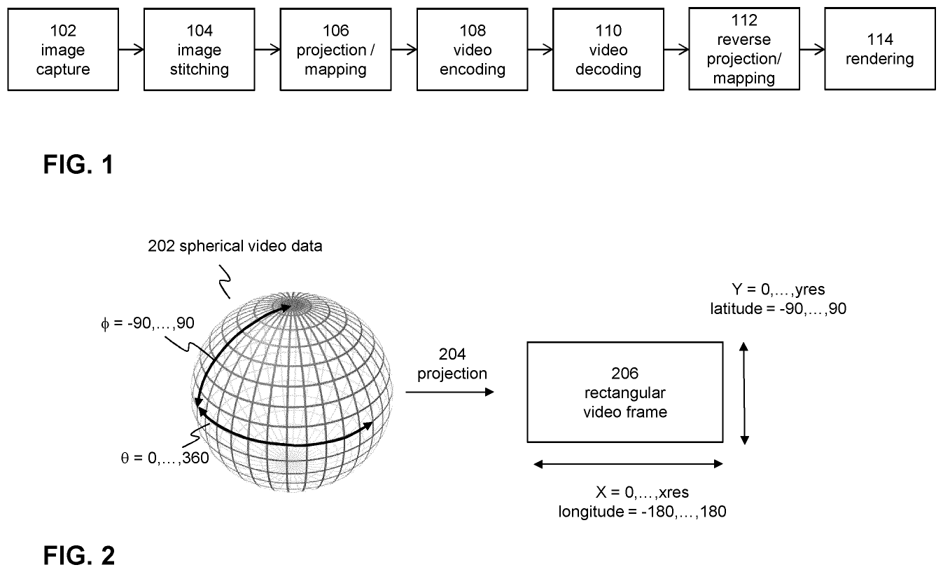

FIG. 1 depicts a high-level flow diagram of a method for processing spherical content. The process may include capturing multiple images (step 102) using a panoramic or 360-degree image capturing system, which typically comprises multiple, i.e. two or more image sensors. Images of overlapping field of views, generated by different image sensors, may be stitched together (step 104) into one panorama or high-resolution image. Stitching of images into one image is a well-known image processing technique, that typically includes alignment and panorama composition. In the alignment process, feature descriptors may be extracted from images in order to find corresponding image features in different images that form a panorama composition. Alignment is used to estimate an image camera pose or orientation of each of the different images. The panorama composition procedure subsequently uses this information for combining the different images into one panorama image. Image blending may be used to seamlessly stitch the combined images together. The stitching of the images may be in a 2D or 3D space. For example, images may be stitched to each other onto a spherical surface thereby forming spherical video data.

Spherical video data of a panorama composition may be transformed and formatted by projection and mapping operations (step 106) into 2D rectangular video frames which are encoded by a state-of-the-art video encoder (step 108). The encoded video data may be encapsulated into a transport container so that the video data can be transmitted to a playout device comprising a video decoder, which is configured to decode the video data (step 110) into 2D rectangular frames. For presentation of the content to the user, the playout device renders a 3D (polyhedronic) object, and textures it with video data of decoded video frames (step 114). Depending on the projection that was used, decoded video frames are transformed back into omnidirectional video data by reversing the packing, mapping and projection operations (step 112). The encoding process 108 may be implemented in a video encoder apparatus and steps 110-114 may be implemented in a media playback device connected to or integrated in e.g. a head mounted display device (HMD).

The transformation of the spherical video data by projection and mapping operations into 2D rectangular video frames is described in more detail with reference to FIG. 2-4. FIG. 2 depicts an example of an equirectangular projection operation 204 of spherical video data 202 represented as pixels on a spherical surface (e.g. a sphere or a squished sphere), onto a rectangular 2D video frame 206. This projection operation may be used to directly transform pixels associated with spherical coordinates ϕ,θ to pixels associated with planar 2D pixels with Cartesian coordinates (X,Y). This way, spherical video data can be transformed into a conventional video frame that can be processed by a conventional video coding system.

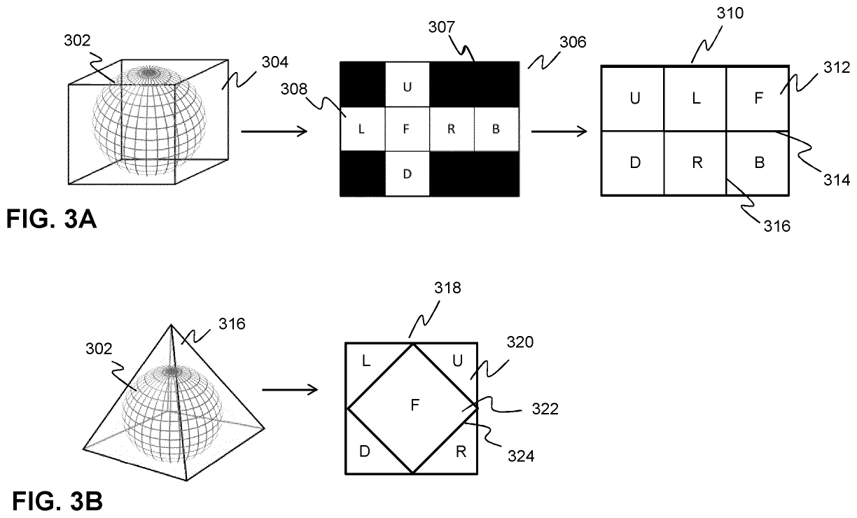

FIGS. 3A and 3B depict projection models for generating projected video frames. FIG. 3A depicts the projection of spherical video data 302 onto a rectangular video frame using a cubic projection model wherein spherical video data are projected onto faces 304 of a cube. These faces may be referred to as projection faces. The orientation of the sphere and the cube may be described using a 3D coordinate system such that different orientations of the sphere, the cube and the sphere relative to the cube can be defined. For example, in such coordinate system the projection faces may be labelled as front face (F), up face (U), down face (D), left face (L), right face (R) and back face (B). After the projection of the pixels onto the projection faces, the faces of the cube may be unfolded so that a planar 2D rectangular video frame 306 is formed wherein faces comprising the projected pixels are arranged in a 2D plane. Here, the pixels belonging to a projection face may be referred to as a pixel region or, in short, a region. For example, pixels associated with the front projection face L 308 of the cube form pixel region L in the rectangular video frame 306. The projection onto a face of a cube and unfolding process of the cube may be referred to as mapping and the result of the mapping may be referred to as a projected video frame. A projected video frame comprises an arrangement of pixel regions wherein edges of pixel regions may form region boundaries. The artificial region boundaries are a direct consequence of the mapping operation and the shape of the pixel regions are a direct consequence of the projection model that is use (in this case a cube projection model).

Depending on the projection model, after mapping, a projected video frame may include some areas 307 that do not comprise any video data. In order to improve compression efficiency, the pixel regions in the projected video frame may be rearranged and resized, hence removing the areas that do not comprise any video data. This process may be referred to as packing. The packing process results in a packed projected video frame 310 including rearranged pixel regions 312 and horizontally and vertically arranged region boundaries 314,316. Similarly, FIG. 3B depicts a pyramidal projection model 314 resulting in a projected video frame 318 including pixel regions 304,310,318,320 and associated region boundaries 306,312,313,322. Depending on the projection type the region boundaries may have different orientations in the video frame. Many different projection types may be used including but not limited to a cylinder, a polyhedron (e.g. an octahedron or an icosahedron), a truncated pyramid, segmented sphere, etc. The mapping and, optionally, packing of spherical video data into a projected video frame results in a video frame comprising a plurality of pixel regions.

In the context of 360 video, it is very likely that the video content will not be captured or computer-generated using a camera rotating around one of its axes. This is because motion in the video that is caused by a rotational camera displacement may trigger motion sickness to the viewer. Translational motion however, in particular slow translational motion, is acceptable for most of the users. Hence, camera motion in 360 video is predominantly translational camera motion. If camera translation is possible, typically a scene in the video content allows the camera to move in a given direction for a good amount time, e.g. a scene captured by a moving drone. This way an “immersive” video experience can be provided to the viewer. This means that a scene world as a function of time is not a small closed 3D geometry like a cube (as may be the case when using a static 360 camera). On the contrary, the scene world may include at least two vertical planes (“walls”) on the left and right parallel to the camera motion and two horizontal planes top and bottom, “sky” and “ground” respectively. In some cases, such as large indoor warehouse, the world scene may be further simplified and can be characterized by only two planes, top and bottom. In yet another case, e.g. outdoor footage, the top plane (sky) can be considered at an infinite distance from the camera and thus can be omitted.

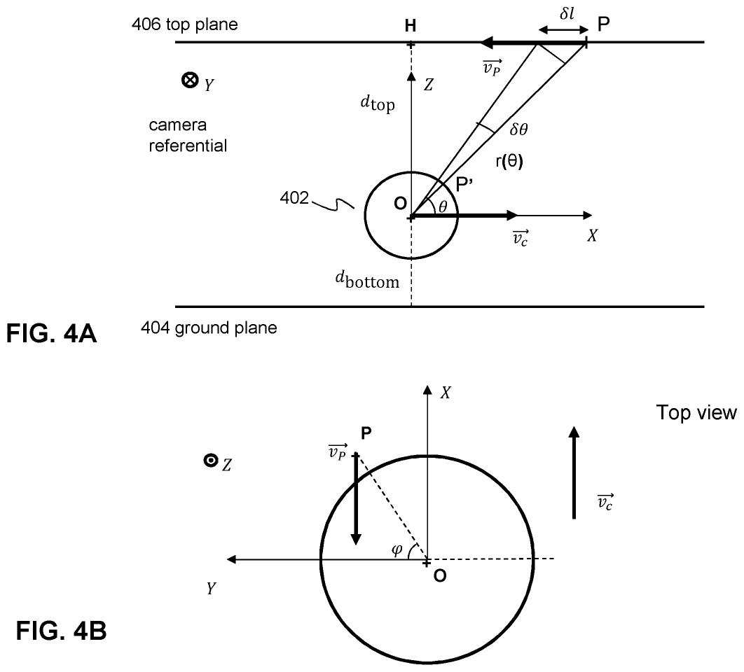

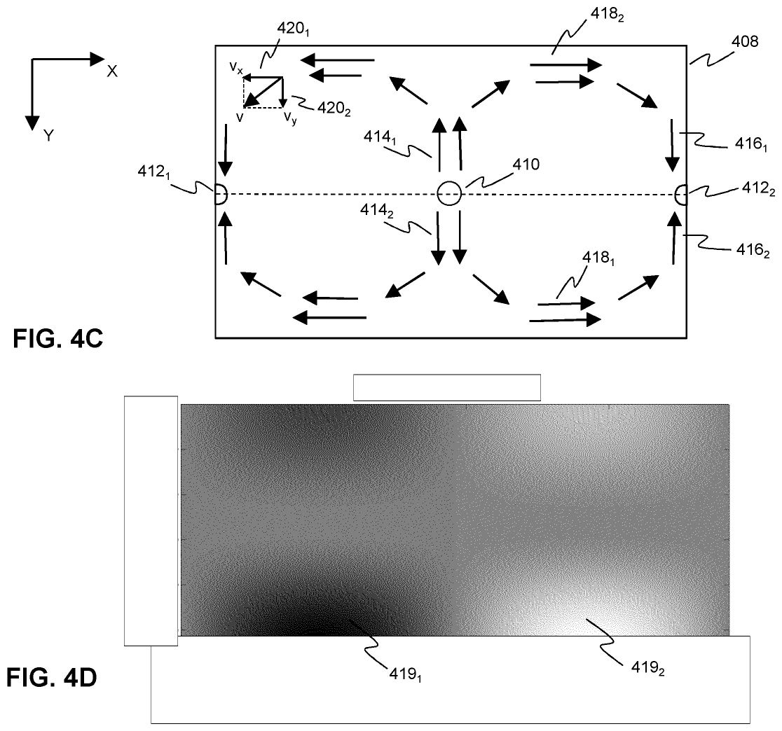

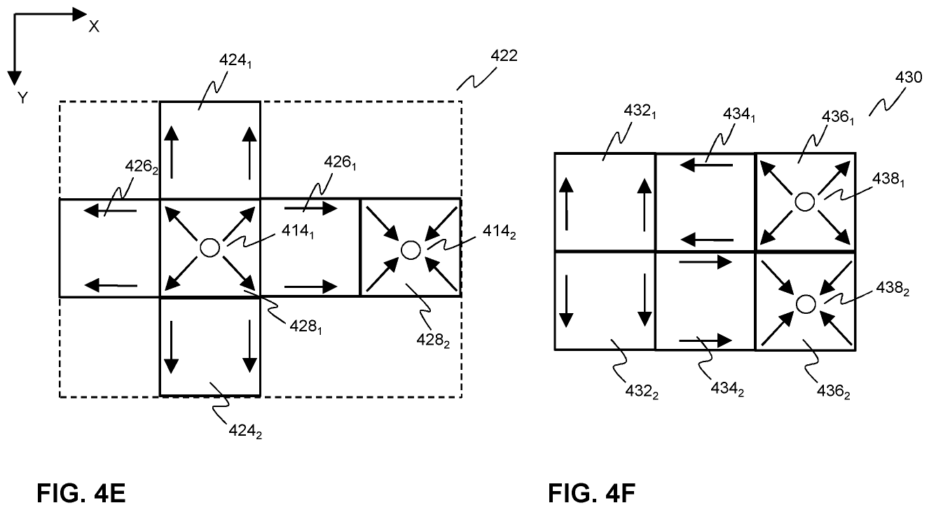

It is well known that in case of translational camera motion, there is a corresponding change in the images captured by the camera. If a camera moves with a certain velocity, a point of a 3D scene world imaged on the image plane of a camera can be assigned a vector indicating a magnitude and direction of the movement of the point on the image plane due to camera movement. The collection of the motion vectors for each point (e.g. pixel or collection of pixels such as a video block) in a video frame may form a motion vector field associated with the video frame. The motion vector field thus forms a representation of 3D motion as it is projected onto a camera image wherein the 3D motion causes a (relative) movement between (parts of) the real-world scene and the camera. The motion vector field can be represented as a function which maps image coordinates to a 2-dimensional vector. The motion fields in projected spherical video due to translational movement of a 360-video camera will exhibit a motion field of a distinct pattern depending on the type of projection that is used to project spherical video onto a rectangular 2D plane. FIG. 4A-4F illustrates the concept of motion fields in projected spherical video data in more detail.

FIG. 4A depicts a side-view of a plane world scene model of a linear moving 360 video camera (i.e. a camera that has a hypothetical spherical capturing surface). FIG. 4B depicts a top-view of the plane world scene model. As shown in FIG. 4A, the spherical surface 402 of the 360 camera, which captures the scene, is schematically depicted as a sphere of radius r. Translational camera movements are typically caused by a displacement of the camera support, e.g. a car, a man, a drone, etc. In this situation, a scene may be modelled as two planes, a ground plane 404 (the “ground”) and a top plane 406 (the “sky”). Here, the terms sky and ground determine the top and bottom planes (but do not necessarily represent a real-world “sky” or a real-world “ground”). For instance, the sky may represent a ceiling in an indoor 360 video. The scene may be further characterised by one or more distances, e.g. ground distance d_{bottom} and sky distance dₜₒₚ, which define the distance between the camera centre O and the ground plane (bottom plane) and the distance between the camera centre and the sky plane (top plane) respectively. If point P represents a point of the top plane, the speed of the point P is given by:

$${v}_{P} = \frac{{dx}_{P}}{dt}$$

In addition, the trigonometric relationship in the triangle OPH gives:

$$sin θ = \frac{{d}_{top}}{r}$$

$$r = \frac{{d}_{top}}{sin θ}$$

$$and$$

$$cos θ = \frac{{x}_{P}}{r}$$

Here, by definition angle θ for all the points of the top plane is within the range [0;π] since dₜₒₚ≠0. The motion visible on the sphere surface is given by an angular velocity of the point P′ intersecting the sphere and the segment OP. Within the frame of reference of the camera, point P, i.e. point P is associated with a non-zero motion vector. In order to determine a displacement of the point P′ on the circle while point P moved by δI, a tangent equation (providing a relation between the position of point P and the angle θ), may be evaluated:

$$tan θ = \frac{{d}_{top}}{{x}_{P}}$$

By deriving the equation with respect to the time, the following expressions of the motion field for the plane world scene may be derived (dₜₒₚ is kept constant with respect to time):

$$\frac{1}{{cos}^{2} θ} \frac{d θ}{dt} = - {d}_{top} \frac{\frac{{dx}_{P}}{dt}}{{x}_{P}^{2}}$$

$${ω}_{P} = - \frac{{d}_{top} {cos}^{2} θ}{{x}_{P}^{2}} {v}_{P}$$

$${ω}_{P} = - {d}_{top} \frac{1}{{r}^{2}} {v}_{P}$$

$${ω}_{P} = - \frac{sin θ}{r} {v}_{P}$$

$${ω}_{P} = \frac{sin - θ}{r} {v}_{P}$$

These equations are valid when \vec{v_{P}} and \vec{v_{C}} are in the same plane OXZ, i.e. P is in the plane OXZ. When P is not in this plane, the point P can be defined in a spherical coordinate system by (r, θ, φ) with φ being the azimuth angle and θ the polar angle in the spherical coordinate system and O its origin. FIG. 4B depicts the angle φ. Further \vec{v_{P}} can be defined in the Cartesian coordinate system as:

$${v}_{P} = \vert \begin{matrix}- {v}_{C} \\ 0 \\ 0\end{matrix}$$

In the case P is not in the plane OXZ, then the previous equation can be generalized by substituting v_{P} with the projection of \vec{v_{P}} onto the line (HP) hence falling back in the case of \vec{v_{P}} and \vec{v_{C}} are aligned which is:

v_{P}=—v_{C} sin φ

This expression provides a horizontal component (an x-component) of the motion field of an EPR projection due camera motion (see also FIG. 4D):

$${ω}_{{P}_{x}} = - \frac{sin - θ}{r} {v}_{C} sin φ$$

In a similar way, the vertical y-component of the motion field can be determined. These expressions indicate that the motion field produced by translational motion in a plane world model is characterized by a specific set of properties and can be analytically modelled using a simple parametric function as described above. As will be shown in the figures, the motion field is either globally zero or characterized by a focus of expansion (an expansion point) and a focus of contraction (contraction point) which are separated by 180 degrees. Moreover, any flow that is present is parallel to the geodesics connecting a focus of expansion to a focus of contraction.

FIG. 4C represents a rectangular frame 408 matching the dimensions of video frames comprising spherical video data (pixels on a sphere) which are projected onto the rectangular frame using an equirectangular (ERP) projection. The projection introduces distortion (warping) around the poles (i.e. pixels at the upper and lower edge of the video frame), which is caused by the stretching that occurs at the poles to fit the projected sphere's surface onto the rectangular frame. Hence, a point on the sphere near a pole of the sphere has more pixels allocated in the projection, in this case an ERP projection, than a point at the equatorial area of the sphere. When a scene is captured by a 360 camera that generates ERP projected video frames, the pattern introduced by the projection may introduce a motion field that has a distinct non-uniform motion pattern around the poles in the video.

For example, the motion field depicted in video frames as shown in FIG. 4C may be associated with a camera moving towards an object in the centre of the rectangular video frame. The motion field is caused by the nature of the 360-video capture and the projection, in this case an ERP projection, that is executed afterwards. If the 360-video is captured outside, the top part of the video will normally encompass the sky. In that case, the motion field is predominantly visible in the bottom part of the video. On the equator, the motion field is null by a linear translation of the camera parallel to the sky and ground. The centre point 410 in the pictures represent an expansion point, i.e. a point where motion fields 414_{1,2} point in opposite directions. The expansion point is the point to which the camera is moving. The point 412_{1,2} on the equator at the edge of the frame is called the compression point, i.e. a point where motion fields 416_{1,2} converge in a single point. In the example that the camera is moving forward, this part is behind the camera.

FIG. 4D provides a graphical representation of the x-component ω_{P}_{ₓ} of the motion field of an EPR projection due to camera motion. The values are calculated on the basis of the above described mathematical expression for ω_{P}_{ₓ}. The concept of a motion field is closely related to the concept of motion vectors of a video frame as determined by a motion estimation process that is used in an inter-prediction scheme of a video coding system. As will be described hereunder in greater detail, in an inter-prediction scheme, motion vectors represent the position of a video block in a video frame based on the position of the same or similar video block in another video frame (a reference video frame). Motion in video will cause pixels of a video block in a video frame to shift from a first position in a first (projected) video frame to second position in a further second (projected) video frame. Thus, when applying a known motion estimation scheme to an EPR projected video frame, the motion vectors of video blocks of the projected video frame (as determined by the motion estimation scheme) will exhibit substantial variation (in magnitude and/or angle) in the areas where the motion field is strongly non-uniform. For example, the white areas 419₁ and black areas 419₂ represent areas in which the x-component of the motion field is relatively large.

The motion vector associated with a certain video block in a video frame represents a shift in (blocks of) pixels due to motion in the video, including motion caused by camera motion. Therefore, the motion field in a projected video frame (which can be accurately modelled) at the position of a video block provides an effective measure of the contribution of the camera motion to the motion vector. As shown in FIG. 4C, the contribution of the motion field to the motion vector can be divided in a contribution to a first motion vector component (the x component 420₁ of the motion vector and a contribution to a second motion vector component (they component 420₂ of the motion vector).

Hence, in the white and black areas of FIG. 4D, the contribution of the camera motion to the motion vectors of the video blocks will be substantial. In contrast, grey areas of FIG. 4D identify areas in the video frame where the motion field is small so that little or negligible contribution of the camera motion to the motion vectors is to be expected. This way, the motion field in a projected video frame is used to determine which motion vectors of the video blocks are affected by camera motion and to what extend they are affected. Since the motion field has a characteristic predictable pattern for a certain projection type, the motion field can be used to improve the video compression.

Although the effect of translational camera movement is explained above with reference to an ERP projection, the described effect, i.e. the distinctive pattern of the non-uniform motion field, will also appear in other projections such as cube map. This is because each of these projections will introduce a characteristic pattern in the video. FIGS. 4E and 4F depict a projected video frame 422 and an associated packed projected video frame 430. The arrows show the directions of the motion field in the different pixel areas, including the pixel areas 428_{1,2} associated with the front and back face of the (virtual) cube. The pixel area associated with the front face may include an expansion point, i.e. a point where motion fields point in opposite directions and the pixel area associated with the back face may include a compression point, i.e. a point where motion fields converge in a single point. The pixel areas may further include pixel areas 426_{1,2} associated with the left and right face of the (virtual) cube and the pixel areas 424_{1,2} associated with the up and down face of the (virtual) cube. When packing the projected video frame, the pixel areas may be rearranged as depicted in FIG. 4D, including pixel areas 432_{1,2} associated with up and down, pixel areas 434_{1,2} associated with left and right and pixel areas 436_{1,2} associated with front and back faces of a (virtual) cube that was used as a projection model. As shown in FIGS. 4E and 4F, motion may cause complex but distinct non-uniform motion fields in the video frames that depend on the way the pixel areas are arranged in the video frames. Hence, a particular arrangement of pixel areas in projected video frames is associated with a particular distinct non-uniform motion field in the video.

Projected video frames that include motion fields due to a moving camera need to be encoded by a state-of-the-art video coding system, e.g. HEVC, AV1, VP10, etc., These video coding systems rely on inter-prediction techniques in order to increase the coding efficiency. These techniques rely on temporal correlations between video blocks in different video frames, wherein the correlation between these blocks can be expressed based on a motion vector. Such motion vector provides an offset of a video block in a decoded picture relative to the same video block in a reference picture (either an earlier video frame or a further video frame). For each video block in the video frame a motion vector can be determined. The motion vectors of all video blocks of a video frame may form a motion vector field. When examining the motion vector field of projected video frames, e.g. video frames comprising ERP or cubic projected video, the motion field at a position of a certain video block provides a measure of the motion of the pixels of that block wherein the motion includes non-uniform global motion due to translational camera movement as described with reference to FIG. 4A-4F.

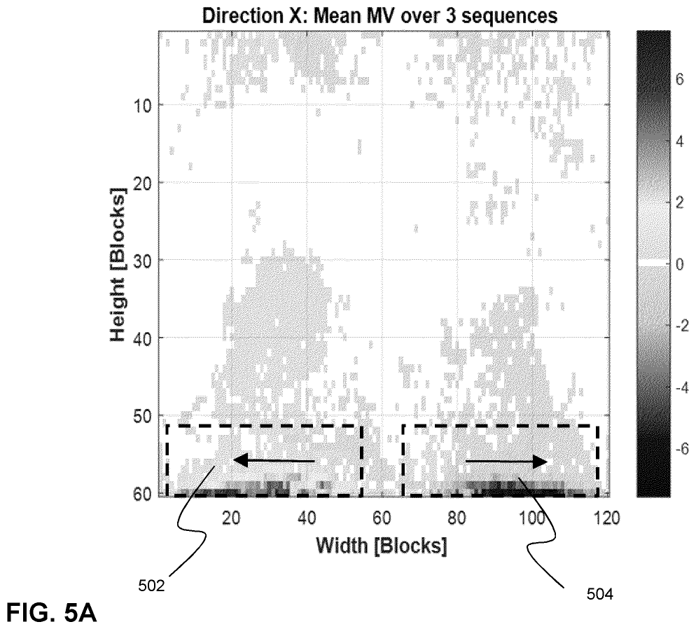

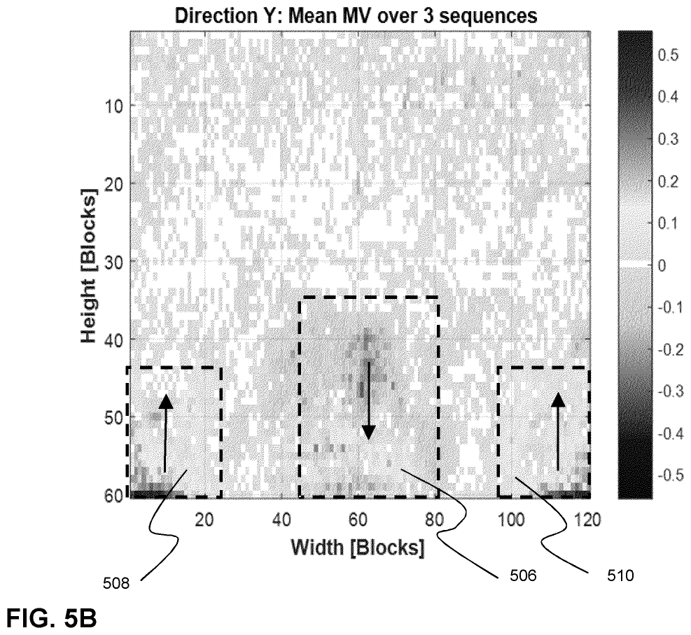

Experimental data of motion vector fields of decoded video frames is depicted in FIGS. 5A and 5B. In particular, FIG. 5A depicts a statistical analysis of the x-component of the motion vector fields of video frames of a video that was captured using a 360-video camera and FIG. 5B depicts a statistical analysis of the y-component of the motion vector fields of the video frames. The analysis was performed on a sequence of video frames with motion vectors comprising ERP projected spherical video. FIG. 5A depicts the horizontal component (X-direction) of the mean motion vector value which is calculated for each of the 60×120 blocks by averaging over 180 frames. The goal of the analysis was to verify whether similar 360 video frames (with centrally located camera moving forwards) exhibit the same characteristic features which can be used to improve the coding efficiency of a set of videos.

As shown in FIG. 5A, the mean MV values in the X direction show linear symmetry dominantly in the bottom part of the graph. As a centrally positioned 360 camera moves forward, the motion vectors 506 in FIG. 5B point downward from the centre of the picture (the expansion point) to the bottom edge. FIG. 5A shows that the motion vectors at the bottom parts of the image symmetrically point away from the centre to the right and left edges and FIG. 5B shows that the motion vectors at the left and right edge point upwards from the bottom edges toward the compression point. The relatively high mean MV values in areas 502 and 504 at the bottom left half and bottom right half of the X component show that MV values in these areas highly correlate with the horizontal (x-axis) components of the motion field of FIG. 4B. On the left bottom half of the X component 502 the mean value is positive as the motion vectors are dominantly oriented to the left, while on the right bottom half 504 the motion vectors are dominantly pointing to the right resulting in negative mean value for the MVs.

The mean MV values for the vertical, Y direction acquired for each of the 60×120 blocks by averaging over the motion vectors of the video frames are shown in FIG. 5B. This graph shows that the MV values highly correlate with the vertical (y-axis) components of the motion field of FIG. 4B, including vertical MV components 506 pointing towards the bottom in the centre of the graph and vertical MV components pointing upwards in the bottom corners 508 and 510.

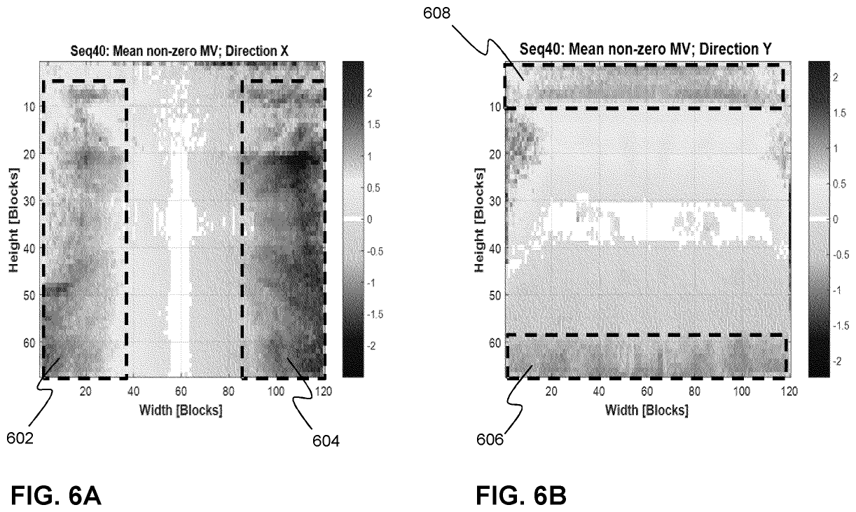

The effect of camera motion causing a non-uniform motion vector field of a distinct pattern in the video and affecting the direction and/or magnitude of the motion vectors determined by a motion estimation module of a video coding system not only occurs in spherical video but also in other types of video such as 2D video. For example, FIGS. 6A and 6B depicts a statistical analysis of the X components of the motion vector field and Y components of the motion vector field of 2D video frames that include a zooming action, which can be regarded as a type of camera motion. As shown by FIG. 6A a non-uniform motion field in the horizontal MV values (horizontal MV values pointing to the left) at the left side of the graph is visible and a non-uniform motion field in the horizontal MV (horizontal MV values pointing to the right) at the right side of the graph is visible. Distinct non-uniform MV patterns can also exist when the camera is moving (e.g. car moving forward).

Hence, from the statistical analysis of the motion vector fields as depicted in FIGS. 5A, 5B, 6A and 6B it follows that camera motion affects the magnitude and/or the direction of motion vectors of video blocks in video frames and introduces a characteristic non-uniform motion pattern, which can be accurately modelled and predicted using a parametric algorithm as e.g. described with reference to FIG. 4. Any suitable type of parametric algorithm for modelling non-uniform motion vector fields may be used, including machine learning algorithms such as a deep neural network that are trained to determine non-uniform motion in a sequence of video pictures. The characteristic non-uniform motion pattern that is introduced in the motion vector field by the movement of the camera will depend on the type of video (2D or spherical video) and—in case of spherical video—the type of projection that is used for projecting the spherical video data onto a rectangular video frame as well as the world scene view, e.g. room, warehouse, outdoor, etc.

State of the art video coding systems such as HEVC, VP9 and AV1, use inter-prediction techniques to reduce the temporal redundancy in a sequence of video pictures in order to achieve efficient data compression. Inter-prediction uses a motion estimation technique to determine motion vectors (MVs), wherein a motion vector identifies reference samples in a reference video frame that is suitable for predicting a video block in a current video frame that needs to be encoded. The reference samples identified by a motion vector may be referred to as a prediction block. The difference between samples of a prediction block and samples of a current video block may define residual samples of a residual video block. Such residual video block, or in short residual block, may be encoded together with metadata, such as the MV, into a bitstream and transmitted to a video playout device that includes a video decoder for decoding the encoded information in the bitstream using the metadata. MVs may be further compressed by exploiting correlations between motion vectors. Translational moving objects in video pictures typically cover many blocks that have similar motion vectors in directions and length. Video coding standards typically exploit this redundancy.

For example, HEVC uses a so-called Advanced Motion Vector Prediction (AMVP) algorithm which aims to improve compression by using motion vectors that have already been calculated as references for predicting a current motion vector. In this scheme, a motion vector predictor (MVP) for a block may be generated by determining candidate motion vectors of already encoded blocks of the current video frame or co-located blocks of an decoded reference video frame and selecting a candidate motion vector as the best predictor for the current block based on an optimization scheme such as a well-known rate distortion and optimization (RDO) scheme. The motion vector difference MVD between the motion vector predictor and the motion vector and information about the selected motion vector predictor may be entropy coded into a bitstream. The decoder may use the information of the selected motion vector predictor and the motion vector difference to reconstruct a motion vector of a block that needs to be decoded.

A problem associated with inter-prediction algorithms used by most coding standards is that these inter-prediction algorithms are based on the assumption that the motion relates to translational movement of objects in the video, which is sometimes referred to as local motion compensation. Motion vectors however provide an estimate of all motion in video blocks of a video frame, including for example local motion associated with moving objects, global motion associated with a moving background caused by a moving camera and any other type of motion. Conventional inter-prediction schemes are optimized for local motion when the spatial correlation between motion vectors is close to an identity function, i.e. neighbour motion vectors tend to have the same amplitude and direction. These inter-prediction schemes are however not designed to deal with other types of motion, such as non-uniform global motion effects. Such non-uniform motion fields are particular dominant where 360-video is captured by a moving camera. The embodiments in this application address this problem.

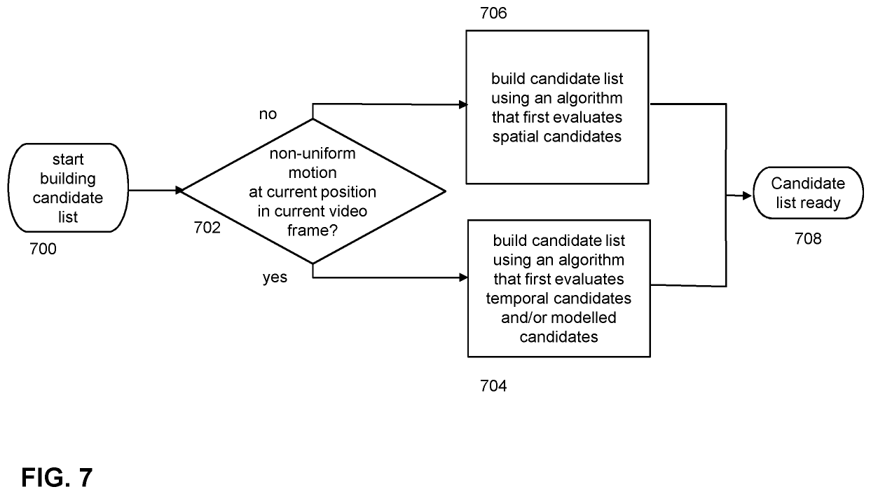

FIG. 7 depicts a motion vector prediction process according to an embodiment of the invention. The process may be part of a motion vector predicting scheme that is used during inter-prediction coding. As shown in this figure, the process may start with the encoder determining or receiving motion information which signals the encoder whether at the current position (e.g. at the position of a current block or tile), in a picture (e.g. a video frame) a non-uniform motion field is present (step 702). Based on the motion information, the encoder may select from a plurality of motion vector predictor algorithms, including at least a first motion vector predictor algorithm and a second motion vector predictor algorithm. If non-uniform motion is present or if the non-uniform motion is above a certain threshold, the encoder may select a motion vector predictor scheme (a first motion vector predictor algorithm), that is configured to handle non-uniform motion, e.g. global motion (step 704). In case no non-uniform motion is present or if the non-uniform motion is below a certain threshold, a motion vector predictor scheme (a second motion vector predictor algorithm) that is optimized for uniform motion (typically translational uniform motion) may be selected by the encoder (step 706). Based on the first or second motion vector predictor algorithm, the encoder may build a candidate list by evaluation of motion vectors associated with blocks that are already encoded (step 708).

In an embodiment, the first motion vector predictor algorithm may be configured to build a list of motion vector predictor candidates by first evaluating already encoded blocks of a reference frame. In an embodiment, if no suitable temporal candidates are found or not enough suitable temporal candidates are found, spatial candidates may be evaluated. In another embodiment, the first algorithm may be configured to only evaluate temporal candidate and not spatial candidates.

In another embodiment, the first motion vector predictor algorithm may be configured to determine a list of motion vector predictor candidates based on a parametric model of the non-uniform motion. For example, the parametric model being used to compute the non-uniform motion at the position of the current block. Examples of such parametric models are described with reference to FIG. 4. Hence, in this embodiment, a parametric model may be used to determine a list of motion vector predictor candidates or at least some of the candidates in the list of motion vector predictor candidates. A motion vector predictor that is computed by the parametric model may be referred to as a modelled candidate. In case a parametric model is used to generate motion vector predictor candidates, metadata transmitted to the decoder should include information about the model, so that the decoder is capable of generating the candidates based on the model. In a further embodiment, the list of motion vector predictor candidates may be determined based on evaluating temporal candidates and modelled candidates. The list of motion vector predictor candidates that is determined based on modelled candidates may be may be extended with one or more temporal candidates and/or one or more spatial candidates.

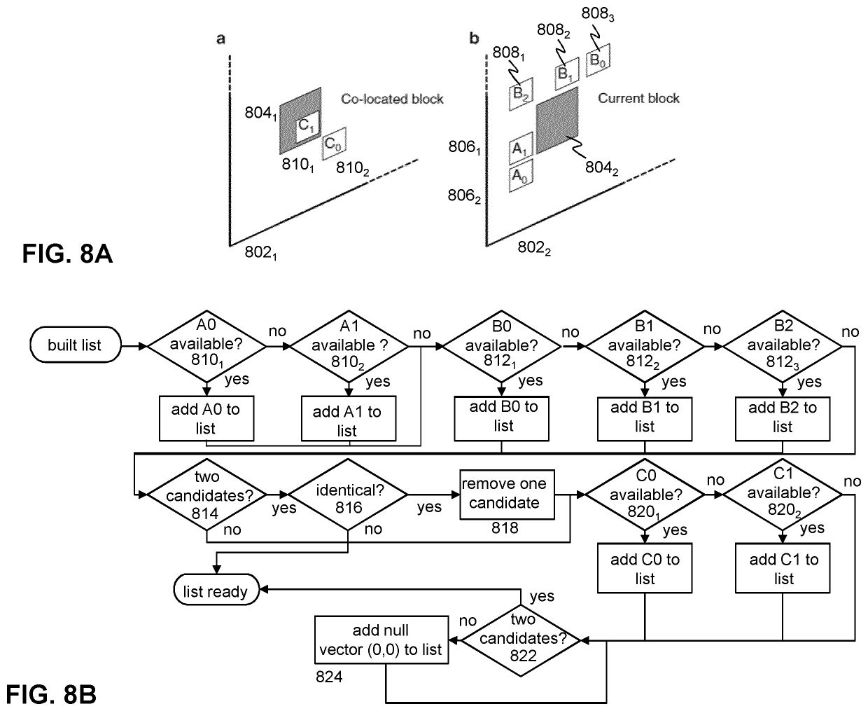

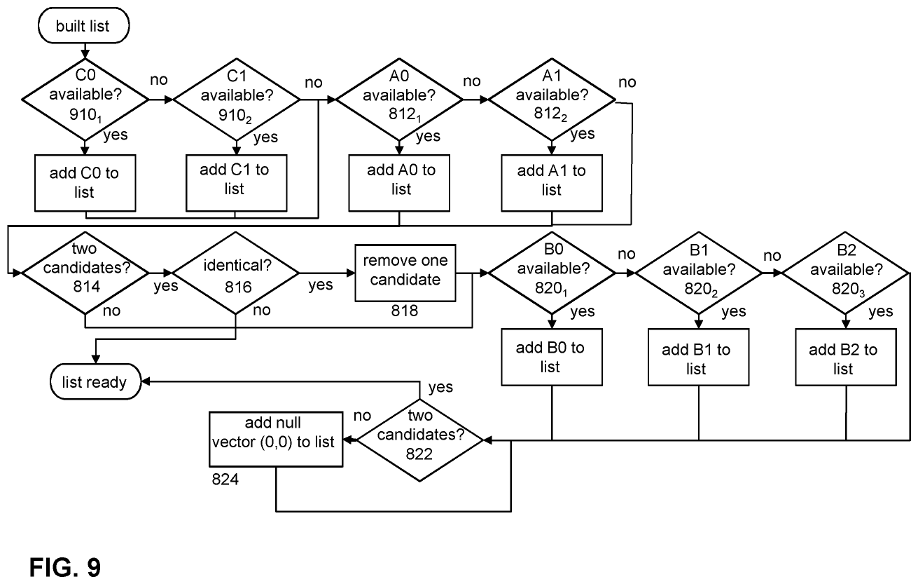

Thus, based on motion information associated with a current block of a current frame, the encoder may decide to use a first motion vector predictor algorithm which is capable to generate suitable motion vector predictor candidates for blocks that have a motion vector that is part of a non-uniform motion field in a part of the current video frame. Deriving a list of candidates by first evaluating temporal candidates (or only on temporal candidates) will provide substantial advantages in efficient encoding of video that comprises non-uniform motion, such as global motion. These advantages are explained in more detail with reference to FIGS. 8A, 8B and 9.

The second motion vector predictor algorithm may be configured to build a list of motion vector predictor candidates by first evaluating already motion vectors of encoded blocks of the current frame, typically encoded blocks in neighbourhood of the current block. These motion vector predictor candidates may be referred to as spatial candidates. If the algorithm does not find any suitable candidates (or not enough candidates) in the current frame, it may evaluate motion vectors of already encoded blocks in a reference frame, typically blocks close to a block in the reference frame that is co-located with the current block of the current frame. These motion vector predictor candidates may be referred to as temporal candidates. Current state of the art coding standards such as HEVC, VP9, AV1 and VVC use schemes wherein first spatial candidates are evaluated and thereafter—if no suitable spatial candidates are found—temporal candidates.

FIG. 8A depicts an example of a sequence of video frames 802_{1,2} including a current frame 802₂ comprising a block 804₂ that needs to be encoded (a current block) and a reference frame 802₁ including a block 804₁ that is co-located with the current block. As already shortly mentioned above, state of the art motion vector predictor algorithms that are optimized for uniform translational motion first evaluate samples of blocks in the current frame that are already encoded for building a list of motion vector predictor candidates.

FIG. 8A may illustrate a schematic representing (a part of) the so-called advanced motion vector prediction (AMVP) scheme known from the HEVC coding standard. As shown in this figure, first samples of two sets of predetermined spatial candidates A0, A1 (A candidates) and B0,B1,B2 (B candidates) are evaluated. These spatial candidates are associated with blocks that have a predetermined position relative to the current block and thereafter—if needed—a samples of a set of temporal candidates C0,C1 (C candidates) are evaluated.

An example of a process of constructing a list of two motion vector predictor candidates is shown in FIG. 8B. As shown in this figure, a list is built by checking the availability of a motion vector with block A0 or block A1 (steps 810_{1,2}). If a motion vector of A0 is available, then this motion vector is added to the list. If this is not the case, the availability of A1 is checked and—if available—the motion vector of A1 is added to the list. Hence, after evaluation of A0 and A1, the list may either contain a motion vector associated with A0 or A1 or no motion vector. Thereafter, the availability of motion vectors of blocks B0-B2 (steps 812₁₋₃) may be sequentially checked. In case the list contains a motion vector of A0 or A1, a motion vector of B0, B1 or B2 may be added to the list, if one the B candidates is available. This will result in a list including either A0 or A1 and one of B0-B2. In case neither A0 nor A1 is available, either none, one or two of the B candidates may be added to the list following the flow diagram of FIG. 9B.

As shown in the figure, after evaluation of the A and B candidates, the algorithm checks if the list contains two candidates (step 814). If the motion vectors are identical (step 816), one candidate is removed from the list and the algorithm continues with the evaluation of the temporal candidates C0 and C1 (steps 820_{1,2}) and checks if—after evaluation of the C candidates—the list contains two candidates (step 822). If this is not the case, a null vector may be added to the list (step 824). Hence, the algorithm is configured to build a list that contains two different motion vector predictor candidates so that the encoder can select the best candidate. When the algorithm of FIG. 8B is used to process blocks that are associated with a non-uniform motion field, the chance that after evaluation of the A and B candidates the list contains two spatial candidates with two different motion vectors is very high. This can be explained by the fact that in a (highly) non-uniform motion field, neighbouring motion vectors may substantially differ from each other.

Hence, in most cases, the algorithm depicted in FIG. 8B will stop after evaluation of the A and B candidates, thus generating a list with spatial candidates only. However, for blocks that contain a high-level of non-uniform motion, the correlation between the motion vectors of these blocks will be low. In other words, motion vectors of neighbouring blocks (spatial candidates) will be—in general—not very good predictors for the current block, while the correlation between the motion vector of the current block and the motion vectors of co-located blocks may have a high correlation. Therefore, as already described with reference to FIG. 7, in an embodiment, the first algorithm may build a candidate list by first evaluating temporal candidates or by only evaluating temporal candidates.

A (non-limiting) example of such algorithm is depicted in FIG. 9. As shown in this figure, the process of building the list may start with the evaluation of motion vectors of encoded blocks of reference frames, i.e. temporal candidates such as the C candidates (steps 910_{1,2}). If one of the temporal candidates is available, the algorithm may further evaluate spatial candidates such as the A candidates (steps 812_{1,2}). After the evaluation of the A candidates, the algorithm may check if the list contains two motion vector predictor candidates (step 814). If that is the case, it subsequently checks if the motion vector predictor candidates are identical or substantially identical (step 816). In case of (substantially) identical candidates, one candidate may be removed from the list and the algorithm may continue evaluate candidates such as the B candidates (steps 820₁₋₃).

The advantage of the embodiment depicted in FIG. 9 is that it uses the A, B and C candidates as used by the HEVC coding standard. More generally, the main idea of FIG. 9 is to reuse the candidates as used by the coding standard (e.g. HEVC, AV1, VP9 of VVC) but to change the sequence of the evaluation of the candidates so that first temporal candidates are evaluated, thereby ensuring that many times (most of the times) the list contains a temporal candidate thereby increasing the chance that the list comprises a good predictor for the motion vector of the current block.

It is noted however that the example of FIG. 9 is only one of the many algorithms that may be used. For example, as already described with reference to FIG. 7, instead of or in addition to first evaluating temporal candidates also modelled candidates computed on the basis of a parametric model may be used to build the list. Further, in an embodiment, the first motion vector predictor algorithm may only evaluate temporal candidates, e.g. different sets of candidates associated with blocks in one or more reference frames which are co-located with the current block or which are neighbouring blocks in the one or more reference frames that are co-located with the current block. Thus, in that case, the evaluation only includes temporal candidates. In yet another embodiment, the plurality of motion vector predictor algorithms may include (at least) three algorithms, wherein depending on the non-uniformity of the motion field of the current blocks, either a first motion vector predictor algorithm (no global motion), a second motion vector predictor algorithm (moderate global motion) or a third motion vector predictor algorithm (high global motion) may be selected. For example, depending on a first threshold and second threshold one of the first, second or third algorithms may be selected, wherein the first algorithm may be configured to first evaluate spatial candidates and thereafter—if necessary—temporal candidates, the second algorithm may be configured to first evaluate temporal candidates and thereafter—if necessary—spatial candidates, and the third candidate may evaluate only temporal candidates. Further, the list of candidates may include more than two candidates. Further, candidates may be organized in two or more lists, e.g. a first list of modelled candidates and a second list of temporal candidates and a third list of spatial candidates.

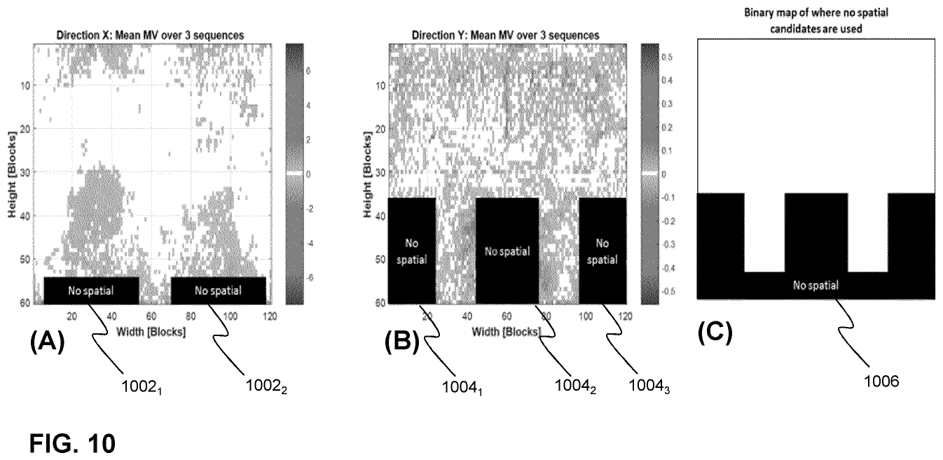

FIG. 10A-10C illustrate an example of motion information according to an embodiment of the invention. In particular, the figures illustrate motion information that may be used by the encoder to select an appropriate motion vector predictor algorithm that may generate a list of candidates that are good predictors for the motion vector of the current block.

FIGS. 10A and 10B respectively depict a mean value of the X and Y component respectively of the averaged motion vector field of a sequence of video frames that originate from an equirectangular projection of spherical video data onto a rectangular area (of a video frame), wherein the spherical video data is captured by a moving camera. (as discussed with reference to FIG. 5). The motion vector components show distinct patterns, 1002_{1,2} for the X component and 1004₁₋₃ for the Y component of the (average) motion vector field. These distinct patterns strongly correlate with the motion field of the simple plane world model as described with reference to FIGS. 4A and 4B. Hence, these figures show that experimentally determined motion vector fields of a particular video type (e.g. 2D or 360 video) and projection type (e.g. ERP or cubic projection) exhibit distinct patterns in the MV field, which cannot be efficiently predicted by a conventional motion vector prediction scheme, which is based on the presumption that spatially neighbouring video blocks in video frames that include motion have motion vectors of approximately the same magnitude and direction. When non-uniform motion such as global motion is introduced into the video this presumption is no longer valid thereby causing a substantial decrease in the compression efficiency.

To counter this problem, a motion vector prediction scheme may be used as described above with reference to FIG. 7-9, wherein different motion vector prediction schemes, e.g. different motion vector prediction algorithms for building a list of motion vector predictor candidates, may be used depending on the location of the current block in the video frame. In order to select an appropriate motion vector predictor algorithm, the encoder may require motion information associated with the video it is encoding. The motion information may signal an encoder which areas in a video frame are affected by global motion and, optionally, provide an indication of the magnitude of the global motion.

In an embodiment, a map, e.g. a binary map, associated with a video frame may be used to signal a decoder which motion vector predictor algorithm to use, e.g. a first motion vector predictor algorithm or a second motion vector predictor algorithm. An example of such map is illustrated in FIG. 10C. The map may be used by an encoder or a decoder to determine whether a block at a particular part of a video frame is located in an area 1006 of high global motion. The encoder may select a motion vector predictor algorithm based on whether a block is located inside or outside such area of high global motion. Such global motion map may be a binary map, including a number of bits (or bytes), wherein each bit (or byte) corresponds to a particular block in the video frame. Such binary map may be efficiently compressed and inserted into the bitstream and transmitted to a decoder.

In another embodiment, the map may be generated by a function in the encoder and decoder. For example, the map may define certain areas which may be defined based on standardized parameters, which can be efficiently compressed and transmitted in the bitstream to the decoder. In yet another embodiment, the encoder and decoder may use a simple parametric function to estimate global motion in video blocks of video frames. A threshold value may be used to determine if the global motion above a certain level so that motion vector predictor candidates are determined by evaluating spatial candidates first or by evaluating only spatial candidates.

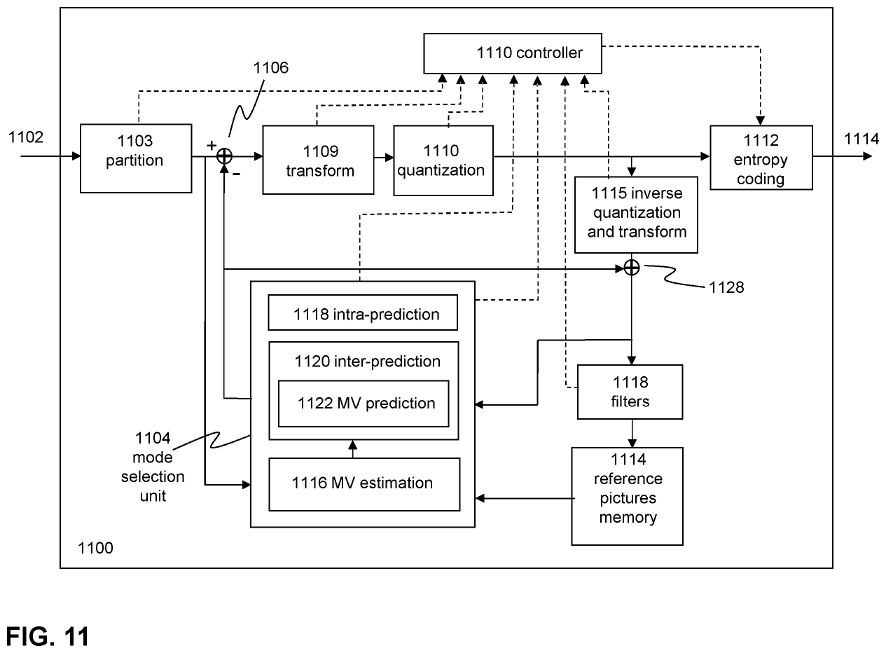

FIG. 11 is a block diagram illustrating a video encoder apparatus 1100 including a motion vector prediction unit according to an embodiment of the invention. Video encoder apparatus 1100 may perform intra- and inter-coding of video blocks within video frames or parts thereof, e.g. video slices. Intra-coding relies on spatial prediction to reduce or remove spatial redundancy in video within a given picture. Inter-coding relies on temporal prediction to reduce or remove temporal redundancy in video within adjacent pictures or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

The video encoder apparatus may receive video data 1102 to be encoded. In the example of FIG. 11, video encoder apparatus 1100 may include partition unit 1103, a mode select unit 1104, summer 1106, transform unit 1108, quantization unit 1110, entropy encoding unit 1112, and reference picture memory 1114. Mode select unit 1104, in turn, may comprise a motion estimation unit 1116, inter-prediction unit 1120, and intra prediction unit 1120. Inter-prediction unit may comprise a motion vector prediction unit 1122, which may be configured to generate a list of motion vector predictor candidates according to the embodiments in this application. For example, the motion vector prediction unit 1122 may be configured to execute a motion vector prediction scheme as described with reference to FIG. 7-9. In case a parametric model of the non-uniform motion is used to generate motion vector predictor candidates, this unit may also include an algorithm representing the parametric model. For video block reconstruction, the video encoder apparatus 1100 may also include inverse quantization and transform unit 1115, and summer 1128. A filter, such as a deblocking filter 1118 may also be included to filter-out artefacts from the reconstructed video frames. Additional loop filters (in loop or post loop) may also be used in addition to the deblocking filter.

The mode select unit 1104 may select one of the coding modes (e.g. intra-prediction or inter-prediction modes based on error results of an optimization function such as a rate-distortion optimization (RDO) function), and provides the resulting intra- or inter-coded block to summer 1106 to generate a block of residual video data (a residual block) to summer 1128 to reconstruct the encoded block for use as a reference picture. During the encoding process, video encoder 1100 may receive a picture or slice to be coded. The picture or slice may be partitioned into multiple video blocks. An inter-prediction unit 1120 in the mode selection unit 1104 may perform inter-prediction coding of the received video block relative to one or more blocks in one or more reference pictures to provide temporal compression. Alternatively, an intra-prediction unit 1118 in the mode selection unit may perform intra-prediction coding of the received video block relative to one or more neighbouring blocks in the same picture or slice as the block to be coded to provide spatial compression. Video encoder may perform multiple coding passes, e.g., to select an appropriate coding mode for each block of video data.

The partition unit 1103 may further partition video blocks into sub-blocks, based on evaluation of previous partitioning schemes in previous coding passes. For example, the partition unit may initially partition a picture or slice into LCUs, and partition each of the LCUs into sub-CUs based on rate-distortion analysis (e.g., rate-distortion optimization). The partitioning unit may further produce a quadtree data structure indicative of partitioning of an LCU into sub-CUs. Leaf-node CUs of the quadtree may include one or more PUs and one or more TUs.

The motion vector estimation unit 1116 may execute a process of determining motion vectors for video blocks. A motion vector, for example, may indicate a displacement Dx,Dy of a prediction block (a prediction unit or PU) of a video block within a reference picture (or other coded unit) relative to the current block being coded within the current picture (or other coded unit). The motion estimation unit may compute a motion vector by comparing the position of the video block to the position of a prediction block of a reference picture that approximates the pixel values of the video block. Accordingly, in general, data for a motion vector may include a reference picture list (e.g. an (indexed) list of already decoded pictures (video frames) stored in the memory of the encoder apparatus), an index into the reference picture list, a horizontal (x) component and a vertical (y) component of the motion vector. The reference picture may be selected from one or more reference picture lists, e.g. a first reference picture list, a second reference picture list, or a combined reference picture list, each of which identify one or more reference pictures stored in reference picture memory 1114.

The MV motion estimation unit 1116 may generate and send a motion vector that identifies the prediction block of the reference picture to entropy encoding unit 1112 and the inter-prediction unit 1120. That is, motion estimation unit 1116 may generate and send motion vector data that identifies a reference picture list containing the prediction block, an index into the reference picture list identifying the picture of the prediction block, and a horizontal and vertical component to locate the prediction block within the identified picture.

Instead of sending the actual motion vector, a motion vector prediction unit 1122 may predict the motion vector to further reduce the amount of data needed to communicate the motion vector. In that case, rather than encoding and communicating the motion vector itself, the motion vector prediction unit 1122 may generate a motion vector difference (MVD) relative to a known motion vector, a motion vector predictor MVP. The MVP may be used with the MVD to define the current motion vector. In general, to be a valid MVP, the motion vector being used for prediction points to the same reference picture as the motion vector currently being coded.

The motion vector prediction unit 1122 may be configured to build a MVP candidate list that may include motion vectors associated with a plurality of already encoded blocks in spatial and/or temporal directions as candidates for a MVP. In an embodiment, the plurality of blocks may include blocks in the current video frame that are already decoded and/or blocks in one or more references frames, which are stored in the memory of the decoder apparatus. In an embodiment, the plurality of blocks may include neighbouring blocks, i.e. blocks neighbouring the current block in spatial and/or temporal directions, as candidates for a MVP. A neighbouring block may include a block directly neighbouring the current block or a block that is in the neighbourhood of the current block, e.g. within a few blocks distance.

The list may be built using an algorithm that is configured to evaluate the blocks in the spatial and/or temporal directions. Depending on the global motion associated with a block, the motion vector prediction unit may select one of a plurality of motion vector predictor algorithms for determining a MVP candidate list. Non-limiting examples of these algorithms as described with reference to FIG. 7-9. The motion vector predictor unit may be configured to receive or determine motion information, which is used by the motion vector prediction unit to select a suitable algorithm.

For example, in an embodiment, it may receive motion information in the form of a map, a global motion map, that signals which of the blocks in the video frames that need to be encoded are associated with global motion of a certain level. In a further embodiment, the map may signal which motion vector predictor algorithm should be used for blocks in a video frame. In an embodiment, the map may be a bitmap, wherein each block is associated with a bit or a bit code that signals a predetermined motion vector predictor algorithm. In another embodiment, it may receive motion information in the form of global motion values which can be used by the decoder (e.g. together with one or more threshold values) to determine which motion vector predictor algorithm should be used. In an embodiment, global motion values may be used to compute an estimate of global motion in a video frame based on a model, e.g. an analytical or a computer model as e.g. described with reference to FIG. 4.

If the motion information signals the decoder that the block is part of a set of blocks that are associated with a non-uniform motion vector field, it may select a motion vector predictor algorithm which is configured to determine motion vector candidates by evaluating temporal candidates. In an embodiment, the algorithm may first evaluate temporal candidates before evaluating spatial candidates. In an embodiment, a motion vector predictor algorithm may be configured to only evaluate temporal candidates. It is further, noted that the plurality of algorithms may be configured as sub-modules of one motion vector prediction algorithm. What matters is that the motion information determines how the motion vector prediction unit builds the list of motion vector predictor candidates. When multiple MVP candidates are available (from multiple candidate blocks), MV prediction unit 1122 may determine a MVP for a current block according to predetermined selection criteria. For example, MV prediction unit 1122 may select the most accurate predictor from the candidate list based on analysis of encoding rate and distortion (e.g., using a rate-distortion cost analysis or other coding efficiency analysis). Other methods of selecting a motion vector predictor are also possible. Upon selecting a MVP, MV prediction unit may determine a MVP index, which may be used to inform a decoder apparatus where to locate the MVP in a reference picture list comprising MVP candidate blocks. MV prediction unit 1122 may also determine the MVD between the current block and the selected MVP. The MVP index and MVD may be used to reconstruct the motion vector of a current block. Typically, the partition unit and mode selection unit (including the intra- and inter-prediction unit and the motion vector predictor unit) and the motion vector estimation unit may be highly integrated. These units are illustrated separately in the figures for conceptual purposes. A residual video block may be formed by an adder 1106 subtracting a predicted video block (as identified by a motion vector) received from mode select unit 1104 from the original video block being coded. The transform processing unit 109 may be used to apply a transform, such as a discrete cosine transform (DCT) or a conceptually similar transform, to the residual video block to form a block of residual transform coefficient values. Transforms that are conceptually similar to DCT may include for example wavelet transforms, integer transforms, sub-band transforms, etc. The transform processing unit 1109 applies the transform to the residual block, producing a transformed residual block. In an embodiment, the transformed residual block may comprise a block of residual transform coefficients. The transform may convert the residual information from a pixel value domain to a transform domain, such as a frequency domain. Transform processing unit 1109 may send the resulting transform coefficients to a quantization unit 1110, which quantizes the transform coefficients to further reduce bit rate.

A controller 1110 may provide syntax elements (metadata) of the encoding process, such as inter-mode indicators, intra-mode indicators, partition information, and syntax information, to entropy coding unit 1114.

Here the syntax elements may include information for signalling (selected) motion vector predictors (for example an indication, e.g. an index in an indexed list, of the MVP candidate selected by the encoder), motion vector differences and metadata associated with the motion vector prediction process as described in the embodiments of this application. The metadata may further include at least part of the motion information that is used by the encoder apparatus to select a motion vector predictor algorithm for determining the list of MVP candidates.

The entropy coding unit 1112 entropy may be configured to encode the quantized transform coefficients and the syntax elements. For example, entropy coding unit may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighbouring blocks. Following the entropy coding by entropy coding unit, the encoded bitstream may be transmitted to another device (e.g., a video decoder) or stored for later transmission or retrieval.

The inverse quantization and inverse transform unit 1115 may be configured to apply an inverse quantization and inverse transformation, respectively, to reconstruct the residual block in the pixel domain, e.g., for later use as a reference block. Inter-prediction unit 1120 may calculate a reference block by adding the residual block to a prediction block of one of the pictures of reference picture memory 1114. Inter-prediction unit 1120 may also apply one or more interpolation filters to the reconstructed residual block to calculate sub-integer pixel values for use in motion estimation. The reconstructed residual block may be added to the motion prediction block produced by the inter-prediction unit 1120 to produce a reconstructed video block for storage in the reference picture memory 1114. The reconstructed video block may be used by motion vector estimation unit 1116 and inter-prediction unit 1120 as a reference block to inter-coding a block in a subsequent picture.

The encoder apparatus may perform a known rate-distortion optimisation (RDO) process in order to find the best coding parameters for coding blocks in a picture. Here, the best coding parameters (including mode decision (intra-prediction or inter-prediction); intra prediction mode estimation; motion estimation; and quantization) refer to the set of parameters that provide the best trade-off between a number of bits used for encoding a block versus the distortion that is introduced by using the number of bits for encoding.

The term rate-distortion optimization is sometimes also referred to as RD optimization or simply “RDO”. RDO schemes that are suitable for AVC and HEVC type coding standards are known as such, see for example, Sze et al. “High efficiency video coding (HEVC).” Integrated Circuit and Systems, Algorithms and Architectures. Springer (2014): 1-375; Section: 9.2.7 RD Optimization. RDO can be implemented in many ways. In one well-known implementation, the RDO problem can be expressed as a minimization of a Lagrangian cost function J with respect to a Lagrangian multiplier:

$$λ \text{::} {min}_{( coding parameters )} J = ( D + λ * R ) .$$

Here, the parameter R represents the rate (i.e. the number of bits required for coding) and the parameter D represents the distortion of the video signal that is associated with a certain rate R. The distortion D may be regarded a measure of the video quality. Known metrics for objectively determining the quality (objectively in the sense that the metric is content agnostic) include means-squared error (MSE), peak-signal-to-noise (PSNR) and sum of absolute differences (SAD).

In the context of HEVC, the rate-distortion cost may require that the encoder apparatus computes a predicted video block using each or at least part of the available prediction modes, i.e. one or more intra-prediction modes and/or one or more inter-prediction modes. The encoder apparatus may then determine a difference video signal between each of the predicted blocks and the current block (here the difference signal may include a residual video block) and transforms each residual video block of the determined residual video blocks from the spatial domain to the frequency domain into a transformed residual block. Next, the encoder apparatus may quantize each of the transformed residual blocks to generate corresponding encoded video blocks. The encoder apparatus may decode the encoded video blocks and compare each of the decoded video blocks with the current block to determine a distortion metric D. Moreover, the rate-distortion analysis may involve computing the rate R for each encoded video block associated with of one of the prediction modes, wherein the rate R includes a number of bits used to signal an encoded video block. The thus determined RD costs, the distortion D and the rate R of the encoded blocks for each of the prediction modes, are then used to select an encoded video block that provides the best trade-off between the number of bits used for encoding the block versus the distortion that is introduced by using the number of bits for encoding.

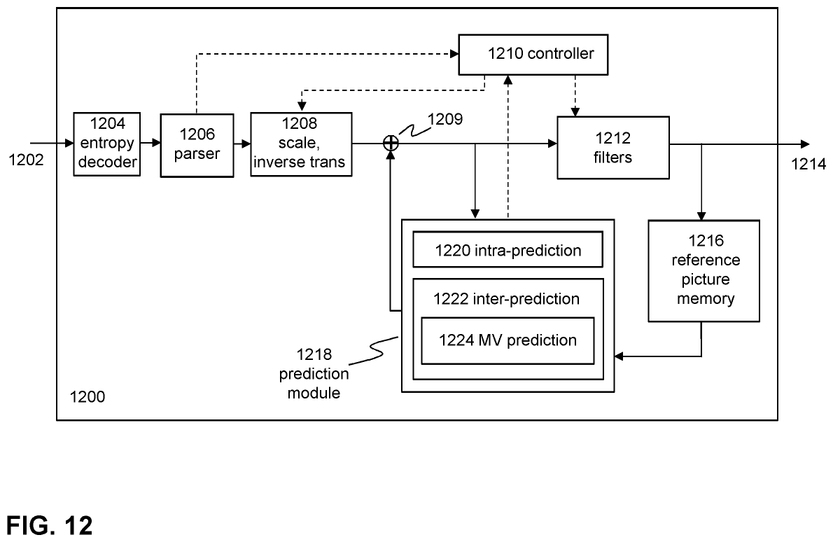

FIG. 12 is a block diagram illustrating an video decoder apparatus 1200 comprising a motion vector prediction unit according to an embodiment of the invention. The decoder apparatus, or in short, decoder apparatus, may be configured to decode a bitstream comprising encoded video data as generated by a video encoder apparatus as described with reference to FIG. 11.

In the example of FIG. 12, video decoder apparatus 1200 may include entropy decoding unit 1204, parser 1206, prediction unit 1218, inverse quantization and inverse transformation unit 1208, summer 1209, and reference picture memory 1216. Here, prediction unit 1218 may include an inter-prediction unit 1222 and intra-prediction unit 1220. Further, the inter-prediction unit may include a motion vector prediction unit 1224. The motion vector prediction unit 1122 may be configured to execute a motion vector prediction scheme as described with reference to FIG. 7-9. In case a parametric model of the non-uniform motion is used to generate motion vector predictor candidates, this unit may also include an algorithm representing the parametric model.

Similar to the motion vector predictor unit of the encoder apparatus of FIG. 11, the motion vector prediction unit of the decoder may be configured to build a MVP candidate list that may include motion vectors of a plurality of blocks, including blocks, such as neighbouring blocks, in the current video frame that are already decoded and/or blocks in one or more references frames, which are stored in the memory of the decoder apparatus.

The list may be determined by an algorithm that is configured to evaluate the blocks in the spatial and/or temporal directions. Depending on the global motion associated with a block, the motion vector prediction unit may select one of a plurality of algorithms for building a MVP candidate list. For example, the algorithms as described with reference to FIG. 7-9.

Decoder apparatus 1200 may be configured to receive an encoded video bitstream 1202 that comprises encoded video blocks and associated syntax elements from a video encoder. Entropy decoding unit 1204 decodes the bitstream to generate a transformed decoded residual blocks (e.g. quantized coefficients associated with residual blocks), motion vector differences, and syntax elements (metadata) for enabling the video decoder to decode the bitstream. The syntax elements may include metadata associated with the motion vector prediction process as described in the embodiments of this application. For example, in an embodiment, the metadata may include an indication of the MVP candidate selected by the encoder. For example, the indication may include an index in an indexed list of MVP candidates. Further, in an embodiment, the metadata may include at least part of the motion information that was used by the encoder to select a motion vector predictor algorithm for determining the list of MVP candidates.

Parser unit 1206 forwards the motion vector differences and associated syntax elements to prediction unit 1218. The syntax elements may be received at video slice level and/or video block level. For example, by way of background, video decoder 1200 may receive compressed video data that has been compressed for transmission via a network into so-called network abstraction layer (NAL) units. Each NAL unit may include a header that identifies a type of data stored to the NAL unit. There are two types of data that are commonly stored to NAL units. The first type of data stored to a NAL unit is video coding layer (VCL) data, which includes the compressed video data. The second type of data stored to a NAL unit is referred to as non-VCL data, which includes additional information such as parameter sets that define header data common to a large number of NAL units and supplemental enhancement information (SEI).

When video blocks of a video frame are intra-coded (I), intra-prediction unit 1220 of prediction unit 1218 may generate prediction data for a video block of the current video slice based on a signalled intra-prediction mode and data from previously decoded blocks of the current picture. When video blocks of a video frame are inter-coded (e.g. B or P), inter-prediction unit 1222 of prediction unit 1218 may produces prediction blocks for a video block of the current video slice based on motion vector differences and other syntax elements received from entropy decoding unit 1204. The prediction blocks may be produced from one or more of the reference pictures within one or more of the reference picture lists stored in the memory of the video decoder. The video decoder may construct the reference picture lists, using default construction techniques based on reference pictures stored in reference picture memory 1216.

Inter-prediction unit 1220 may determine prediction information for a video block of the current video slice by parsing the motion vector differences and other syntax elements and using the prediction information to produce prediction blocks for the current video block being decoded. For example, inter-prediction unit 1220 uses some of the received syntax elements to determine a prediction mode (e.g., intra- or inter-prediction) which was used to code the video blocks of the video slice, an inter-prediction slice type (e.g., B slice or a P slice), construction information for one or more of the reference picture lists for the slice, motion vector predictors for each inter-encoded video block of the slice, inter-prediction status for each inter-coded video block of the slice, and other information to decode the video blocks in the current video slice. In some examples, inter-prediction unit 1220 may receive certain motion information from motion vector prediction unit 1224.

The decoder apparatus may retrieve a motion vector difference MVD and an associated encoded block representing a current block that needs to be decoded. In order to determine a motion vector based on the MVD, the motion vector prediction unit 1224 may determine a candidate list of motion vector predictor candidates associated with a current block. The motion vector predictor unit 1224 may be configured to build a list of motion vector predictors in the same way as done by the motion vector predictor unit in the encoder. Thus, based on motion information, the motion vector predictor unit may select one motion vector prediction algorithm from a plurality of motion vector predictor algorithms and use the selected motion vector predictor algorithm to determine a list of motion vector prediction candidates. The motion vector prediction unit may select a motion vector prediction algorithm as e.g. described with reference to FIG. 7-9.

The motion vector prediction algorithm may evaluate motion vector predictor candidates which are associated with blocks in the current frame or a reference frame that have a predetermined position (typically neighbouring) relative to the position of the current block. These relative positions are known to the encoder and the decoder apparatus. Thereafter, the motion vector prediction unit may select a motion vector predictor MVP from the list of motion vector prediction candidates based on the indication of the selected motion vector predictor candidate which was transmitted in the bitstream to decoder. Based on the MVP and the MVD the inter-prediction unit may determine a prediction block for the current block.

Inverse quantization and inverse transform unit 1208 may inverse quantize, i.e., de-quantizes, the quantized transform coefficients provided in the bitstream and decoded by entropy decoding unit. The inverse quantization process may include the use of a quantization parameter calculated by video encoder for each video block in the video slice to determine a degree of quantization and, likewise, a degree of inverse quantization to be applied. It may further apply an inverse transform, e.g., an inverse DCT, an inverse integer transform, or a conceptually similar inverse transform process, to the transform coefficients in order to produce residual blocks in the pixel domain.

After the inter-prediction unit 1220 has generated the prediction block for the current video block, the video decoder may form a decoded video block by summing a residual block with the corresponding prediction block. The adder 1209 represents the component or components that perform this summation operation. If desired, a deblocking filter may also be applied to filter the decoded blocks to remove blocking artefacts. Other loop filters (either in the coding loop or after the coding loop) may also be used to smooth pixel transitions, or otherwise improve the video quality. The decoded video blocks in a given picture are then stored in reference picture memory 1216, which stores reference pictures which may be used for subsequent coding of further current blocks. Reference picture memory 1216 also stores decoded video for later presentation on a display device.

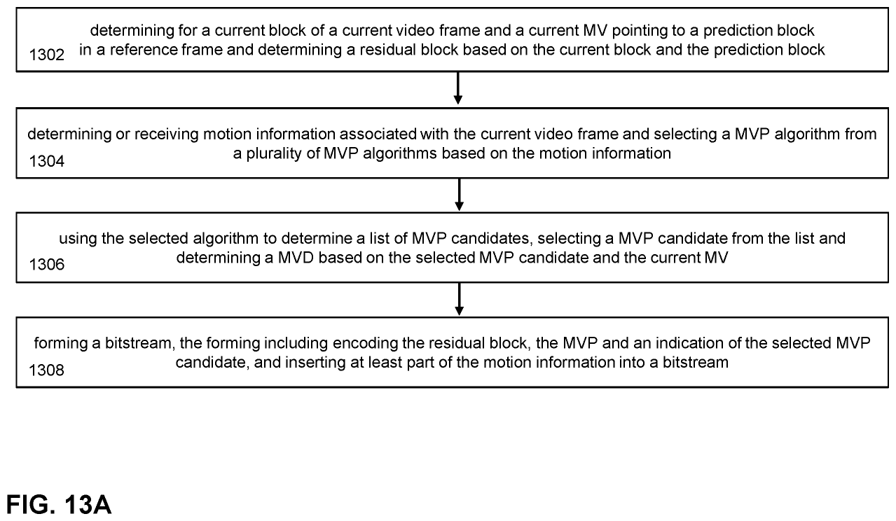

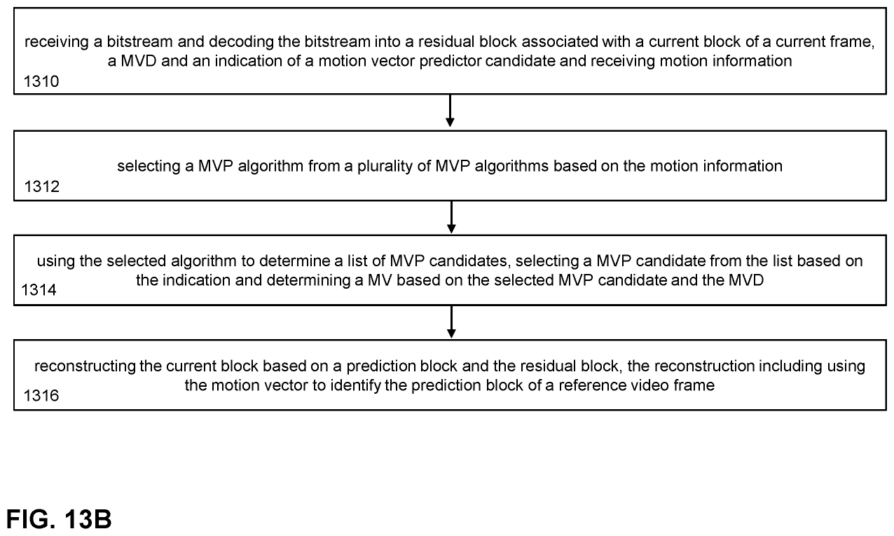

FIGS. 13A and 13B depict flow-charts of an encoding process and a decoding process according to various embodiments of the invention. The processes may be implemented as encoding and decoding processes executed the encoding and decoding devices as described with reference to FIGS. 11 and 12 respectively.

The encoding process depicted in FIG. 13A may include determining for a current block of a current video frame a current MV pointing to a prediction block in a reference frame and determining a residual block based on the current block and the prediction block (step 1302). The encoder apparatus may determine a motion vector (MV) for a current video block that needs to be encoded. A well-known motion vector estimation process may be used to determine the motion vector wherein each motion vector may indicate the displacement (offset) of a video block within a current picture relative to a video block within a decoded reference picture stored in the memory of the encoder apparatus (e.g. a decoded video frame preceding or succeeding the current video frame). The video block in the reference frame the motion vector is pointing to may be referred to as a prediction block. Then, a residual video block may be determined based on a difference between the current block and the prediction block. A residual block may be determined based on a difference of video samples (e.g. pixel values) in a video block in the current frame and a prediction block, i.e. a video block in a reference frame that is identified by a motion vector. In an embodiment, the video frames may be projected video frames, i.e. video frames generated by mapping spherical video onto a rectangular 2D frame using a projection model as e.g. described with FIGS. 2 and 3. A projected video frame may comprise an arrangement of pixel regions which are a direct consequence of the projection model that is used, wherein during the projection the image may be distorted (warped) due to the projection.

In a further step 1304, the encoder apparatus may determine or receive motion information associated with the current video frame and select a MVP algorithm from a plurality of MVP algorithms based on the motion information. For example if the motion information informs the encoder apparatus that a current block is associated with a non-uniform motion field (e.g. the current block is part of a set of blocks for which the differences between motion vectors in magnitude and/or direction are higher than a certain threshold value), then the encoder apparatus may select an MVP algorithm which first (or only) evaluates temporal MVP candidates, i.e. motion vectors of blocks in a reference frame alternatively or in additional it may evaluate modelled MVP candidates. If the motion information informs the encoder apparatus that a current block is associated with a uniform motion field (e.g. the current block is part of a set of blocks for which the differences between motion vectors in magnitude and/or direction are lower than a certain threshold value), the encoder apparatus may select an MVP algorithm, which first evaluates spatial MVP candidates, i.e. motion vectors of block in the current video frame that are already encoded.

In step 1306, the selected algorithm may be used to determine a list of MVP candidates. An MVP candidate may be selected from the list on the basis of an optimization scheme such as a rate distortion optimization scheme. Based on the selected MVP candidate and the current MV a motion vector difference may be determined. In a further step 1308, a bitstream is formed, wherein the formation may include encoding the residual block, the motion vector difference MVD and an indication of the selected MVP candidate using an encoding scheme, e.g. an entropy encoding scheme. Further, the formation of the bitstream may include inserting at least part of the motion information into a bitstream so that the motion information can be transmitted in-band to a receiver. In another embodiment, the motion information can be transmitted in an out-of-band channel to the receiver.

The decoding process depicted in FIG. 13B may include a decoder apparatus receiving a bitstream and decoding the bitstream into residual blocks and associated syntax elements (step 1310). The residual blocks may include a residual block of a current block that needs to be decoded and associated syntax elements, including a MVD and an indication of a motion vector predictor candidate. Further, the decoder apparatus may receive motion information either in the bitstream (in-band) or in an out-of-band transmission channel.

The decoder apparatus may use the motion information to select a motion vector prediction algorithm from a plurality of MVP algorithms that reside in the memory of the decoder apparatus (step 1312) and the selected algorithm may be used to determine a list of MVP candidates. Further, the indication of the selected MVP candidate may be used to select a MVP candidate from the list and a MV may be formed based on the selected MVP candidate and the MVD (step 1314). Finally, the method may include a step of reconstructing the current block based on a prediction block and the residual block, the reconstruction including using the motion vector to identify the prediction block of a reference video frame (step 1316).

Hence, as shown by the process of FIGS. 13A and 13B, based on the motion information the encoder and the decoder may select a motion vector prediction algorithm that is best suitable for predicting a motion vector for the current block. The invention is especially effective for determining motion vector predictors for blocks in a video frame that include a relatively large global motion component. This way efficient compression of high resolution video that includes global motion can be achieved.

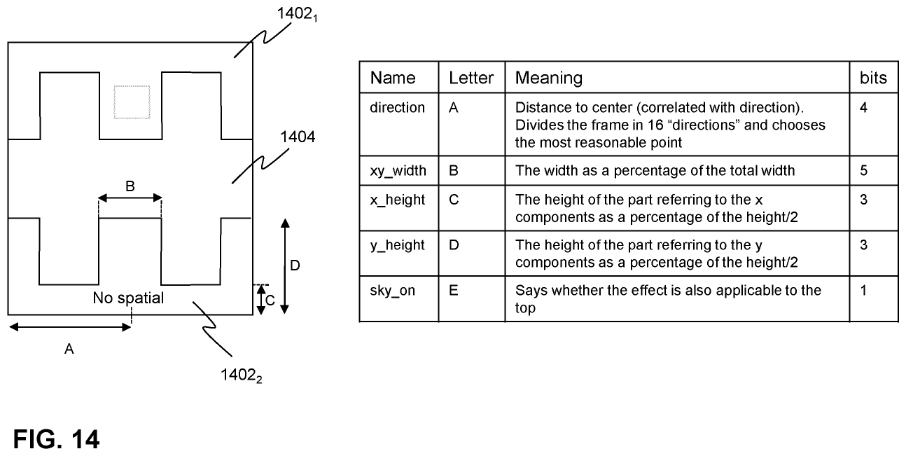

FIG. 14 illustrates an example of motion information in the form of a parameterized global motion function. A predetermined number of parameters may define a map for video frames indicating one or more first regions 1402_{1,2} comprising blocks associated with a substantial non-uniform motion vector field (e.g. a set of blocks for which the differences between motion vectors in magnitude and/or direction are higher than a certain threshold value). A first motion vector predictor algorithm may be used to determine motion vector predictor candidates for blocks in these first regions. Further, the map may include one or more second regions 1404 comprising blocks associated with a substantial uniform motion vector field (e.g. a set of blocks for which the differences between motion vectors in magnitude and/or direction are lower than a certain threshold value). For these regions, a second motion vector predictor algorithm may be used to determine motion vector predictor candidates. As shown in the figure, the regions may be defined using certain parameters A,B,C determining the position and the dimensions (height, width, reference point (centre), etc.) of the first and second regions in the map. Such map is especially useful for video frames that include predictable patterns of global motion, e.g. video frames including video as described above with reference to the non-limiting examples of FIG. 1-6. The table in FIG. 14 describes a number of exemplary parameters.

The motion information may be formatted into a suitable data format so that it can be inserted in the bitstream together with the video data. For example, in an embodiment, the parameters may be inserted in a header of a suitable data structure of the bitstream. The type of data structure may depend on the video coding standard that is used for encoding and decoding. For example, a Tile Group header as defined in the VVC coding standard may be used to send the motion information to a decoder apparatus. In another embodiment, a Slice header as defined in the AVC and HEVC coding standards may be used to send the motion information to the decoder apparatus. In another embodiment, the parameters may be inserted in one or more NAL units, in particular non-VCL NAL units, such as a picture parameter set (PPS) or a Sequence Parameter Set (SPS). An example of a PPS is provided in table 1:

TABLE 1

| | Descriptor |
|---|---|
| picture_parameter_set_rbsp( ) { | |
| pps_pic_parameter_set_id | ue(v) |
| pps_seq_parameter_set_id | ue(v) |
| ... | |
| AMVP_constructor_map | u(1) |
| if(AMVP_constructor_map) { | |
| direction | u(4) |
| xy_width | u(5) |
| x_height | u(5) |
| y_height | u(3) |
| sky_on | u(1) |
| } | |
| } | |

Thus, the motion information may further include, information signalling in which part or parts of the video frame or tile no spatial candidates should be used.

Alternatively, in further embodiment, the motion information may include a flag, e.g. a binary flag, associated with one or more blocks in a video frame. The flag may signal a decoder apparatus that when constructing a list of MVP candidates for a block in a video frame, a slice or a tile, no spatial candidates should be used for determining the list of motion vector predictor candidates. For example, such flag may signal the processor to use either a first motion vector predictor algorithm or a second motion vector predictor algorithm.

In a further embodiment, the motion information may include a binary map comprising a string of values, for example a string of bits or bytes, wherein each value is associated with a block in a frame and each value signaling a decoder to use a first motion vector predictor algorithm or the second motion vector predictor algorithm.

In an embodiment, the motion information described with reference to the embodiments may be sent inside the bitstream itself, for example just before the motion vectors, the a decoder apparatus. Alternatively, in an embodiment, the motion information may be sent in an out-of-band to the decoder apparatus.

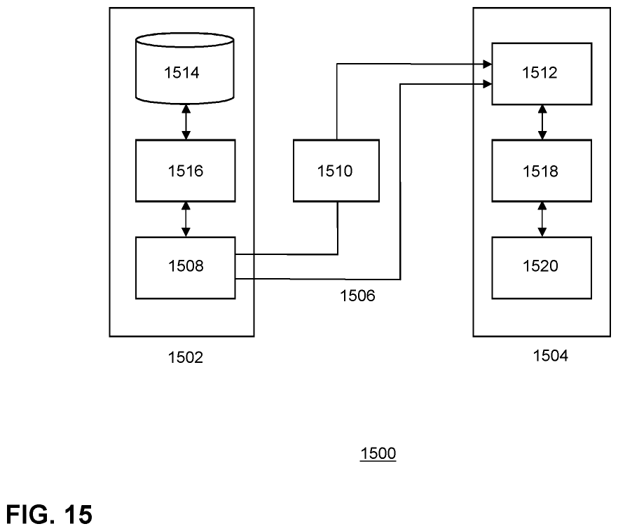

FIG. 15 depicts a schematic of a video encoding and decoding system 1500 that may use the techniques described in this application. As shown in FIG. 15, system 1500 may include a first video processing device 1502, e.g. a video capturing device or the like, configured to generate encoded video data which may be decoded by a second video processing device 1504, e.g. a video playout device. First and second video processing devices may include any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, The video processing devices may be equipped for wireless communication.

The second video processing device may receive the encoded video data to be decoded through a transmission channel 1506 or any type of medium or device capable of moving the encoded video data from the first video processing device to the second video processing device. In one example, the transmission channel may include a communication medium to enable the first video processing device to transmit encoded video data directly to the second video processing device in real-time. The encoded video data may be transmitted based on a communication standard, such as a wireless communication protocol, to the second video processing device. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, servers or any other equipment that may be useful to facilitate communication between first and second video processing devices.

Alternatively, encoded data may be sent via an I/O interface 1508 of the first video processing device to a storage device 1510. Encoded data may be accessed by input an I/O interface 1512 of the second video processing device. Storage device 1510 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may hold the encoded video generated by the first video processing device. The second video processing device may access stored video data from storage device via streaming or downloading. The file server may be any type of server capable of storing encoded video data and transmitting that encoded video data to the second video processing device. Example file servers include a web server (e.g., for a website), an FTP server, network attached storage (NAS) devices, or a local disk drive. The second video processing device may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 36 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 1500 may be configured to support one-way or two-way video transmission to support applications such as video streaming, video playback, video broadcasting, and/or video telephony.

In the example of FIG. 15, the first video processing device may further include a video source 1514 and a video encoder 1516. In some cases, I/O interface 1508 may include a modulator/demodulator (modem) and/or a transmitter. The video source may include any type of source such as a video capture device, e.g., a video camera, a video archive containing previously captured video, a video feed interface to receive video from a video content provider, and/or a computer graphics system for generating computer graphics data as the source video, or a combination of such sources. If video source 1514 is a video camera, the first and second video processing device may form so-called camera phones or video phones. However, the techniques described in this disclosure may be applicable to video coding in general, and may be applied to wireless and/or wired applications.

The captured, pre-captured, or computer-generated video may be encoded by video encoder 1516. The encoded video data may be transmitted directly to the second video processing device via I/O interface 1508. The encoded video data may also (or alternatively) be stored onto storage device 1510 for later access by the second video processing device or other devices, for decoding and/or playback.

The second video processing device may further comprise a video decoder 1518, and a display device 1520. In some cases, I/O interface 1512 may include a receiver and/or a modem. I/O interface 1512 of the second video processing device may receive the encoded video data. The encoded video data communicated over the communication channel, or provided on storage device 1510, may include a variety of syntax elements generated by video encoder 1516 for use by a video decoder, such as video decoder 1418, in decoding the video data. Such syntax elements may be included with the encoded video data transmitted on a communication medium, stored on a storage medium, or stored a file server.

Display device 1520 may be integrated with, or external to, the second video processing device. In some examples, second video processing device may include an integrated display device and also be configured to interface with an external display device. In other examples, second video processing device may be a display device. In general, display device displays the decoded video data to a user, and may comprise any of a variety of display devices such as a liquid crystal display (LCD), a plasma display, an organic light emitting diode (OLED) display, or another type of display device.

Video encoder 1516 and video decoder 1518 may operate according to a video compression standard, such as the High Efficiency Video Coding (HEVC), VP9, AV1 or VVC. Alternatively, video encoder 1516 and video decoder 1518 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard.

Although not shown in FIG. 15, in some aspects, video encoder 1516 and video decoder 1518 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 1516 and video decoder 1518 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 1516 and video decoder 1518 may be included in one or more encoders or decoders, either of which may be integrated as part of a combined encoder/decoder (CODEC) in a respective device.

This disclosure may generally refer to video encoder “signaling” certain information to another device, such as video decoder. The term “signaling” may generally refer to the communication of syntax elements and/or other data (metadata) used to decode the compressed video data. Such communication may occur in real- or near-real-time. Alternately, such communication may occur over a span of time, such as might occur when storing syntax elements to a computer-readable storage medium in an encoded bitstream at the time of encoding, which then may be retrieved by a decoding device at any time after being stored to this medium.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware. The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. Method of providing a bitstream comprising video data encoded by an encoder apparatus, the method including:
a processor of the encoder apparatus determining a current motion vector of a current block of a current video frame of a sequence of video frames comprising video data, the current motion vector defining a spatial offset of the current block relative to a prediction block of a previously encoded reference video frame stored in a memory of the encoder apparatus;
the processor determining or receiving motion information, the motion information defining whether the current block is part of a set of blocks in the current video frame that is associated with a non-uniform motion vector field, preferably a non-uniform global motion vector field, in the video data of the current video frame;
the processor determining a motion vector predictor candidate, wherein the determining includes:
selecting one of a plurality of motion vector predictor algorithms, the plurality of motion vector predictor algorithms including at least a first motion vector predictor algorithm and a second motion vector predictor algorithm, the selection being based on the motion information;
determining a list of motion vector predictor candidates based on the selected motion vector predictor algorithm;
selecting the motion vector predictor candidate from the list of motion vector predictor candidates, preferably the selecting being based on an optimization scheme such as a rate distortion optimization process;
the processor determining a motion vector difference based on the selected motion vector predictor candidate and the current motion vector; and,
the processor generating a bitstream, the generating including encoding the motion vector difference, an indication of the selected motion vector predictor candidate and a residual block, the residual block defining a difference between the current block and the prediction block and, optionally, inserting an indication of the selected motion vector predictor algorithm or at least part of the motion information into the bitstream.

2. Method according to claim 1 wherein selecting one of a plurality of motion vector predictor algorithms includes:
selecting the first motion vector predictor algorithm, if the motion information defines that the current block is part of a set of blocks that are associated with a non-uniform motion vector field; and,
selecting the second motion vector predictor algorithm, if the motion information signals the processor that the current block is part of a set of blocks that are associated with a uniform motion vector field.

3. Method according to claim 2 wherein determining a list of motion vector predictor candidates includes:
the first motion vector predictor algorithm determining at least part of the list of motion vector predictor candidates based on one or more motion vectors of one or more already encoded blocks of one or more reference video frames stored in the memory of the encoder apparatus; or,
the first motion vector predictor algorithm determining at least part of the list of motion vector predictor candidates based on a parametric model of the non-uniform motion vector field, preferably the parametric model representing a parametric algorithm configured to compute the non-uniform motion vector field at the position of the current block.

4. Method according to claim 2 wherein determining a list of motion vector predictor candidates includes:
the second motion vector predictor algorithm determining at least part of the list of motion vector predictor candidates based on first evaluating one or more motion vectors of one or more already encoded blocks of the current video frame; and, optionally, after evaluating one or more motion vectors of one or more already encoded blocks of the current video frame, evaluating one or more motion vectors of one or more already encoded blocks of one or more reference video frames stored in the memory of the encoder apparatus.

5. Method according to claim 1 wherein the motion information includes one or more parameters for a map function, the map function being configured to determine one or more first regions in the current frame for which the first motion vector predictor algorithm is used and, optionally, one or more second regions in the current frame for which the second motion vector predictor algorithm is used.

6. Method according to claim 1 wherein the motion information includes a value for signaling the processor to use the first motion vector predictor algorithm or the second motion vector predictor algorithm.

7. Method according to claim 1 wherein the motion information includes a map, preferably a binary map, the map including a plurality of data units, e.g. bits or bytes, each data unit being associated with a block of the current frame, each data unit including a value for signaling the processor to use the first motion vector predictor algorithm or the second motion vector predictor algorithm.

8. Method according to claim 1 wherein video frames of the sequence of video frames comprise spherical video data projected onto a rectangular video frame based on a projection model, more preferably the projection model being an equirectangular or a cubic projection model.

9. Method according to claim 1 wherein the at least part of the motion information is included in the bitstream as one or more network abstraction layer, NAL, units, preferably a non-VCL NAL unit such as a Picture Parameter Set, PPS, or a Sequence Parameter Set, SPS as defined in the HEVC coding standard, or included in the bitstream in a Slice Header as defined in the VVC coding standard or in a Slice Header as defined in the AVC or HEVC coding standard; and/or, wherein the encoding process is based on a coding standard, preferably a block-based video coding standard, more preferably an AVC, HEVC, VP9, AV1, VVC coding standard or a coding standard based on one of the AVC, HEVC, VP9, AV1, VVC coding standards.

10. Method according to claim 1 wherein the processor determining motion information includes:
comparing a magnitude and/or a direction of motion vectors of blocks in a region of the current video frame; and,
determining that the motion vectors in the region belong to a non-uniform motion field based on the compared magnitudes and/or directions.

11. A method for reconstructing a block of a video frame from a bitstream encoded by an encoder apparatus, the method comprising:
a processor of a decoder apparatus receiving a bitstream comprising an encoded current block of a current video frame to be decoded by the decoder apparatus based on one or more already decoded prediction blocks of one or more reference video frames stored in the memory of the decoder apparatus and based on a current motion vector representing a spatial offset of the current block relative to one of the one or more prediction blocks, the current motion vector being associated with a motion vector predictor candidate;
the processor receiving an indication of a motion vector predictor algorithm selected by an encoder for determining a list of motion vector predictor candidates from which the encoder has selected the motion vector predictor candidate; or, the processor receiving motion information defining whether the current block is part of a set of blocks in the current frame that is associated with a non-uniform motion vector field, preferably a non-uniform global motion vector field;
the processor decoding the encoded current block into a residual block, a motion vector difference and an indication of the selected motion vector predictor candidate, the residual block defining a difference between one of the one or more already decoded prediction blocks and the current block;
the processor determining the motion vector predictor candidate, the determining including:
selecting one of a plurality of motion vector predictor algorithms, the plurality of motion vector predictor algorithms including at least a first motion vector predictor algorithm and a second motion vector predictor algorithm, the selection being based on the indication of a motion vector predictor algorithm or the motion information;
determining the list of motion vector predictor candidates based on the selected motion vector predictor algorithm;
selecting the motion vector predictor candidate from the list of motion vector predictor candidates using the indication of a motion vector predictor candidate;
the processor determining the current motion vector based on the selected motion vector predictor candidate and the motion vector difference; and,
the processor reconstructing the current block based on the prediction block and the residual block, the reconstructing including using the current motion vector to identify the prediction block of a reference video frame stored in the memory of the decoder apparatus.

12. Method according to claim 11 wherein the processor selecting one of a plurality of motion vector predictor algorithms based on the motion information includes:
selecting the first motion vector predictor algorithm, if the motion information defines that the current block is part of a set of blocks that are associated with a non-uniform motion vector field; and,
selecting the second motion vector predictor algorithm, if the motion information defines that the current block is part of a set of blocks that are associated with a uniform motion vector field.

13. Method according to claim 11 wherein determining a list of motion vector predictor candidates includes:
the first motion vector predictor algorithm determining at least part of the list of motion vector predictor candidates based on one or more motion vectors of one or more already encoded blocks of one or more reference video frames stored in the memory of the encoder apparatus; or,
the first motion vector predictor algorithm determining at least part of the list of motion vector predictor candidates based on a parametric model of the non-uniform motion vector field, preferably the parametric model representing a parametric algorithm configured to compute the non-uniform motion vector field at the position of the current block.

14. An encoding apparatus comprising:
a computer readable storage medium having at least part of a program embodied therewith; and, a computer readable storage medium having computer readable program code embodied therewith, and a processor, preferably a microprocessor, coupled to the computer readable storage medium, wherein responsive to executing the computer readable program code, the processor is configured to perform executable operations comprising:
determining a current motion vector of a current block of a current video frame of a sequence of video frames comprising video data, the current motion vector defining a spatial offset of the current block relative to a prediction block of a previously encoded reference video frame stored in a memory of the encoder apparatus;
determining or receiving motion information, the motion information defining the processor whether the current block is part of a set of blocks in the current video frame that is associated with a non-uniform motion vector field, preferably a non-uniform global motion vector field, in the video data of the current video frame;
determining a motion vector predictor candidate, wherein the determining includes:
selecting one of a plurality of motion vector predictor algorithms, the plurality of motion vector predictor algorithms including at least a first motion vector predictor algorithm and a second motion vector predictor algorithm, the selection being based on the motion information;
determining a list of motion vector predictor candidates based on the selected motion vector predictor algorithm;
selecting the motion vector predictor candidate from the list of motion vector predictor candidates, preferably the selecting being based on an optimization scheme such as a rate distortion optimization process;
determining a motion vector difference based on the selected motion vector predictor candidate and the current motion vector; and,
generating a bitstream, the generating including encoding the motion vector difference, an indication of the selected motion vector predictor candidate and a residual block, the residual block defining a difference between the current block and the prediction block and, optionally, inserting an indication of the selected motion vector predictor algorithm or at least part of the motion information into the bitstream.

15. A decoding apparatus comprising:
a computer readable storage medium having at least part of a program embodied therewith; and, a computer readable storage medium having computer readable program code embodied therewith, and a processor, preferably a microprocessor, coupled to the computer readable storage medium, wherein responsive to executing the computer readable program code, the processor is configured to perform executable operations comprising:
receiving a bitstream comprising an encoded current block of a current video frame to be decoded by the decoder apparatus based on one or more already decoded prediction blocks of one or more reference video frames stored in the memory of the decoder apparatus and based on a current motion vector representing a spatial offset of the current block relative to one of the one or more prediction blocks, the current motion vector being associated with a motion vector predictor candidate;
receiving an indication of a motion vector predictor algorithm selected by an encoder for determining a list of motion vector predictor candidates from which the encoder has selected the motion vector predictor candidate; or, receiving motion information defining whether the current block is part of a set of blocks in the current frame that is associated with a non-uniform motion vector field, preferably a global motion vector field;
decoding the encoded current block into a residual block, a motion vector difference and an indication of the motion vector predictor candidate selected by an encoder apparatus, the residual block defining a difference between one of the one or more already decoded prediction blocks and the current block;
determining the motion vector predictor candidate, the determining including:
selecting one of a plurality of motion vector predictor algorithms, the plurality of motion vector predictor algorithms including at least a first motion vector predictor algorithm and a second motion vector predictor algorithm, the selection being based on the indication of a motion vector predictor algorithm or the motion information;
determining the list of motion vector predictor candidates based on the selected motion vector predictor algorithm;
selecting the motion vector predictor candidate from the list of motion vector predictor candidates using the indication of the motion vector predictor candidate selected by the encoder to select the motion vector predictor candidate from the list of motion vector predictor candidates;
determining the current motion vector based on the selected motion vector predictor candidate and the motion vector difference; and,
reconstructing the current block based on the prediction block and the residual block, the reconstructing including using the current motion vector to identify the prediction block of a reference video frame stored in the memory of the decoder apparatus.

16. Computer program product comprising software code portions configured for, when run in the memory of a computer, executing the method steps according to claim 1.
